(19) United States
(12) Patent Application Publication
(10) Pub. No.: US 2018/0031811 A1
(43) Pub. Date: Feb. 1, 2018

(54) OPTICAL SYSTEM, OPTICAL DEVICE, AND METHOD FOR ADJUSTING OPTICAL SYSTEM

(71) Applicant: Nikon Corporation, Minato-ku, Tokyo (JP)

(72) Inventors: Satoshi MIWA, Yokohama-shi (JP); Masashi YAMASHITA, Tokyo (JP)

(21) Appl. No.: 15/550,440

(22) PCT Filed: Feb. 25, 2016
(86) PCT No.: PCT/JP2016/055630

§ 371 Date: Aug. 11, 2017

(30) Foreign Application Priority Data
Feb. 27, 2015 (JP) 2015-038234

(51) Int. Cl. G02B 15/167; G02B 7/04; G02B 27/64; G02B 13/02; G02B 27/00

(52) U.S. Cl. CPC G02B 15/167; G02B 13/02; G02B 27/0037; G02B 27/646; G02B 7/04

(57) ABSTRACT

An optical system includes: a first lens group having a positive refractive power, a second lens group having a negative refractive power, and a third lens group, disposed in this order along an optical axis starting from an object side, wherein: the second lens group is movable along the optical axis to perform focusing from an infinity-distance object to a short-distance object; and the third lens group comprises: a vibration-proofing lens group configured to be movable in a direction having a component perpendicular to the optical axis to perform image surface correction on image blurring; and an adjustment lens group that is disposed closer to an image side than the vibration-proofing lens group is, the adjustment lens group including a negative lens Ln and a lens group having a positive refractive power, disposed next to the negative lens Ln, and the adjustment lens group being capable of adjusting an air gap between the negative lens Ln and the lens group having a positive refractive power.

### TECHNICAL FIELD

The present invention relates to an optical system optimal for application in photographic cameras, electronic still cameras, video cameras and the like, to an optical device provided with this optical system, and to a method for adjusting an optical system.

### BACKGROUND ART

Telephoto type optical systems with an internal focusing system have been used widely as optical systems having a large focus length for application in photographic cameras, video cameras and the like (see, for instance, PTL1).

### CITATION LIST

### Patent Literature

PTL1: Japanese Laid-Open Patent Publication No. 2013-218088

### SUMMARY OF INVENTION

### Technical Problem

However, conventional optical systems have experienced loss of imaging performance due to manufacturing errors.

### Solution to Problem

An optical system according to a first aspect of the present invention comprises: a first lens group having a positive refractive power, a second lens group having a negative refractive power, and a third lens group, disposed in this order along an optical axis starting from an object side, wherein: the second lens group is movable along the optical axis to perform focusing from an infinity-distance object to a short-distance object; and the third lens group comprises: a vibration-proofing lens group configured to be movable in a direction having a component perpendicular to the optical axis to perform image surface correction on image blurring; and an adjustment lens group that is disposed closer to an image side than the vibration-proofing lens group is, the adjustment lens group including a negative lens Ln and a lens group having a positive refractive power, disposed next to the negative lens Ln, and the adjustment lens group being capable of adjusting an air gap between the negative lens Ln and the lens group having a positive refractive power.

According to a second aspect of the present invention, in the optical system according to the first aspect, it is preferable that the lens group having a positive refractive power in the adjustment lens group is a lens group G3adjA having a positive refractive power, disposed at the image side of the negative lens Ln.

According to a third aspect of the present invention, in the optical system according to the first aspect, it is preferable that the lens group having a positive refractive power in the adjustment lens group is a lens group G3adjB having a positive refractive power, disposed at the object side of the negative lens Ln.

According to a fourth aspect of the present invention, in the optical system according to the first aspect, it is preferable that the lens group having a positive refractive power in the adjustment lens group includes the lens group G3adjA having a positive refractive power disposed at the image side of the negative lens Ln and the lens group G3adjB having a positive refractive power disposed at the object side of the negative lens Ln.

According to a fifth aspect of the present invention, in the optical system according to the second or fourth aspect, it is preferable that the lens group G3adjA is constituted with one positive lens.

According to a sixth aspect of the present invention, in the optical system according to the third or fourth aspect of the present invention, it is preferable that in the lens group G3adjB is constituted with at most two lenses.

According to a seventh aspect of the present invention, in the optical system according to the third or fourth aspect of the present invention, it is preferable that the lens group G3adjB is constituted with one positive lens or with a combination of one positive lens and one negative lens.

According to an eighth aspect of the present invention, in the optical system according to the fourth aspect, it is preferable that the negative lens Ln is in a bi-concave form.

According to a ninth aspect of the present invention, in the optical system according to any one of the second, fourth, fifth and eighth aspects, it is preferable that a conditional expression (1) below is satisfied:

3.0<f/fRA<15.0 (1)

where:
f: a focal length of the optical system in whole; and
fRA: a combined focal length of the lens group G3adjA through a lens located closest to the image side.

According to a tenth aspect of the present invention, in the optical system according to any one of the second, fourth, eighth, and ninth aspects, it is preferable that a conditional expression (2) below is satisfied:

2.0<f/dR<10.0 (2)

where:
f: a focal length of the optical system in whole; and
dR: a distance on the optical axis from a lens surface in the lens group G3adjA, which is located closest to the object side, to an image surface.

According to an 11th aspect of the present invention, in the optical system according to any one of the second, fourth, fifth and eighth to tenth aspects, it is preferable that a conditional expression (3) below is satisfied:

0.10<f/−fFA<1.00 (3)

where:
f: a focal length of the optical system in whole; and
fFA: a combined focal length of a lens which is located closest to the obj6ect side through the negative lens Ln.

According to a 12th aspect of the present invention, in the optical system according to any one of the second, fourth, fifth and eighth to 11th aspects, it is preferable that conditional expressions (4) and (5) below are satisfied:

|R1A−R2A|/f<0.050 (4)

0.010<(R1A+R2A)/f<0.600 (5)

where:
R1A: a radius of curvature at a surface of the negative lens Ln on the image side;
R2A: a radius of curvature at a surface of the lens group G3adjA on the object side; and
f: a focal length of the optical system in whole.

According to a 13th aspect of the present invention, in the optical system according to any one of the second, fourth, fifth, and eighth to 12th aspects, it is preferable that a conditional expression (6) below is satisfied:

0.005<IIIA/IA·(y/f)² (6)

where:
IIIA: a sum of coefficients of third-order astigmatism from the lens group G3adjA to a lens located closest to the image side in a state where the focal length of the optical system in whole is normalized to be 1;
IA: a sum of coefficients of third-order spherical aberration from the lens group G3adjA to the lens located closest to the image side in a state where the focal length of the optical system in whole is normalized to be 1;
y: a maximum image height of the optical system; and
f: a focal length of the optical system in whole.

According to a 14th aspect of the present invention, in the optical system according to any one of the second, fourth, fifth and eighth to 13th aspects, it is preferable that a conditional expression (7) below is satisfied:

0.005<IIIA·(y/f)²<0.060 (7)

where:
IIIA: a sum of coefficients of third-order astigmatism from the lens group G3adjA to a lens located closest to the image side in a state where the focal length of the optical system in whole is normalized to be 1;
y: a maximum image height of the optical system; and
f: a focal length of the optical system in whole.

According to a 15th aspect of the present invention, in the optical system according to any one of the second, fourth, fifth, and eighth to 13th aspects, it is preferable that in the third lens group, the negative lens Ln and the lens group G3adjA with its convex surface facing the object side are disposed next to each other in this order, starting from the object side.

According to a 16th aspect of the present invention, in the optical system according to any one of the second, fourth, fifth and eighth to 15th, it is preferable that a conditional expression (8) below is satisfied:

0.001<dM/f<0.010 (8)

where:
dM: a distance of an air gap between the negative lens Ln and the lens group G3adjA along the optical axis; and
f: a focal length of the optical system in whole.

According to a 17th aspect of the present invention, in the optical system according to any one of the second, fourth, fifth and eighth to 16th aspects, it is preferable that the negative lens Ln is held by a first holding member and the lens group G3adjA is held by a second holding member.

According to an 18th aspect of the present invention, in the optical system according to the 17th aspect, it is preferable that the air gap between the negative lens Ln and the lens group G3adjA is adjustable by varying a number of gap adjustment members disposed as sandwiched between the first holding member and the second holding member.

According to a 19th aspect of the present invention, in the optical system according to any one of the third, fourth and sixth to eighth aspects, it is preferable that a conditional expression (9) below is satisfied:

1.00<f/fFB<2.70 (9)

where:
f: a focal length of the optical system in whole; and
fFB: a combined focal length of a lens located closest to the object side through the lens group G3adjB.

According to a 20th aspect of the present invention, in the optical system according to any one of the third, fourth, sixth to eighth, and 19th aspects, it is preferable that a conditional expression (10) below is satisfied:

0.0050<dSA/f<0.0500 (10)

where:
dSA: a distance of an air gap between the lens group G3adjB and the negative lens Ln along the optical axis; and
f: a focal length of the optical system in whole.

According to a 21st aspect of the present invention, in the optical system according to any one of claims 3, 4, 6 to 8, 19, and 20, wherein: a conditional expression (11) below is satisfied:

1.3<f/−fRB<6.5 (11)

where:
f: a focal length of the optical system in whole; and
fRB: a combined focal length of the negative lens Ln through a lens located closest to the image side.

According to a 22nd aspect of the present invention, in the optical system according to any one of the third, fourth, sixth to eighth, and 19th to 21st aspects, it is preferable that conditional expressions (12) and (13) below are satisfied:

|R1B−R2B|/f<0.150 (12)

0.150<(R1B+R2B)/f<0.500 (13)

where:
R1B: a radius of curvature at a surface of the lens group G3adjB on the image side;
R2B: a radius of curvature at a surface of the negative lens on the object side; and
f: a focal length of the optical system in whole.

According to a 23rd aspect of the present invention, in the optical system according to any one of the third, fourth, sixth to eighth, and 19th to 22nd aspects, it is preferable that a conditional expression (14) below is satisfied:

IIIB/IB·(y/f)²<0.010 (14)

where:
IIIB: a sum of coefficients of third-order astigmatism from the negative lens Ln to a lens located closest to the image side in a state where the focal length of the optical system in whole is normalized to be 1;
IB: a sum of coefficients of third-order spherical aberration from the negative lens Ln to a lens located closest to the image side in a state where the focal length of the optical system in whole is normalized to be 1;
y: a maximum image height of the optical system; and
f: a focal length of the optical system in whole.

According to a 24th aspect of the present invention, in the optical system according to any one of the third, fourth, sixth to eighth, and 19th to 23rd aspects, it is preferable that a conditional expression (15) below is satisfied:

1.20<−IB<4.70 (15)

where:
IB: a sum of coefficients of third-order spherical aberration from the negative lens to a lens located closest to the image side in a state where the focal length of the optical system in whole is normalized to be 1.

According to a 25th aspect of the present invention, in the optical system according to any one of the third, fourth, sixth to eighth, and 19th to 24th aspects, it is preferable that in the third lens group, the lens group G3adjB with its convex surface facing the object side and the negative lens Ln are disposed next to each other in this order, starting from the object side.

According to a 26th aspect of the present invention, in the optical system according to any one of the third, fourth, sixth to eighth, and 19th to 25th aspects, it is preferable that the negative lens Ln is held by a first holding member and the lens group G3adjB is held by a third holding member.

According to a 27th aspect of the present invention, in the optical system according to the 26th aspect of the present invention, in the air gap between the negative lens Ln and the lens group G3adjB is adjustable by varying a number of gap adjustment members disposed as sandwiched between the first holding member and the third holding member.

According to a 28th aspect of the present invention, in the optical system according to any one of the fourth to 16th and 19th to 25th aspects, it is preferable that the negative lens Ln is held by a first holding member, the lens group G3adjA is held by a second holding member, and the lens group G3adjB is held by a third holding member.

According to a 29th aspect of the present invention, in the optical system according to the 28th aspect, it is preferable that the air gap between the negative lens Ln and the lens group G3adjA is adjustable by varying a number of gap adjustment members disposed as sandwiched between the first holding member and the second holding member, and the air gap between the negative lens Ln and the lens group G3adjB is adjustable by varying a number of gap adjustment members disposed as sandwiched between the first holding member and the third holding member

According to a 30th aspect of the present invention, in the optical system according to any one of the first to 29th aspects, it is preferable that a conditional expression (16) below is satisfied:

0.20<TL3/f1<0.50 (16)

where:
TL3: a distance on the optical axis from a lens surface of the third lens group located closest to the object side to a lens surface of the third lens group located closest to the image side; and
f1: a focal length of the first lens group.

According to a 31st aspect of the present invention, in the optical system according to any one of the first to 30th aspect of the present invention, it is preferable that a conditional expression (17) below is satisfied:

0.65<TL/f<1.15 (17)

where:
TL: a distance on the optical axis from a lens surface of the optical system in whole located closest to the object side to a lens surface of the optical system in whole located closest to the image side; and
f: a focal length of the optical system in whole.

According to a 32nd aspect of the present invention, in the optical system according to any one of the first to 31st aspects, it is preferable that a conditional expression (18) below is satisfied:

0.30<f/f12<1.00 (18)

where:
f: a focal length of the optical system in whole; and
f12: a combined focal length of the first lens group and the second lens group in an infinity-distance object in-focus state.

According to 33rd aspect of the present invention, in the optical system according to any one of the first to 32nd aspects, it is preferable that the second lens group is movable along the optical axis toward the image side to perform focusing from an infinity-distance object to a short-distance object.

An optical device according to a 34th aspect of the present invention comprises the optical system according to any one of the first to 33rd aspects.

A method, according to a 35th aspect of the present invention, for adjusting an optical system that includes a first lens group having a positive refractive power, a second lens group having a negative refractive power, and a third lens group, disposed in this order along an optical axis starting from an object side, wherein the second lens group is movable along the optical axis to perform focusing from an infinity-distance object to a short-distance object; and the third lens group has a vibration-proofing lens group that is movable in a direction having a component perpendicular to the optical axis to perform image surface correction on image blurring, wherein: the third lens group further includes an adjustment lens group that is constituted with a negative lens Ln and a lens group having a positive refractive power next to the negative lens, and that is located closer to an image side than the vibration-proofing lens group is; and an air gap between the negative lens Ln and the lens group having a positive refractive power is adjusted.

According to a 36th aspect of the present invention, in the method for adjusting an optical system according to the 35th aspect, it is preferable that the lens group having a positive refractive power of the adjustment lens group is a lens group G3adjA having a positive refractive power, disposed on the image side of the negative lens Ln.

According to a 37th aspect of the present invention, in the method for adjusting an optical system according to the 35th aspect, it is preferable that the lens group having a positive refractive power of the adjustment lens group is a lens group G3adjB having a positive refractive power, disposed on the object side of the negative lens Ln.

### BRIEF DESCRIPTION OF DRAWINGS

FIG. 1 is a figure showing a sectional view of the configuration adopted in an optical system achieved in a first example of the present invention in an infinity-distance object in-focus state;

FIG. 2 is a figure showing an enlarged sectional view illustrating an adjustment mechanism of an adjustment lens group of the optical system according to the first example;

FIG. 3(a) is a figure showing various types of aberrations occurring at the optical system according to the first example in an infinity-distance object in-focus state and FIG. 3(b) is a figure showing a lateral aberration in a vibration-proofing state;

FIG. 4(a) is a figure showing various types of aberrations occurring at the optical system according to the first example when the surface distance d26 is made by 0.2 mm larger than the design value, and FIG. 4(b) is a figure showing various types of aberrations when the surface distance d24 is made by 0.2 mm larger than the design value;

FIG. 5 is a figure in a sectional view showing the configuration adopted in an optical system according to a second example in an infinity-distance object in-focus state;

FIG. 6(a) is a figure showing various types of aberrations occurring at the optical system according to the second example in an infinity-distance object in-focus state, and FIG. 6(b) is a figure showing a lateral aberration in a vibration-proofing state;

FIG. 7(a) is a figure showing various types of aberrations occurring at the optical system according to the second example when the surface distance d30 is made by 0.2 mm larger than the design value, and FIG. 7(b) is a figure showing various types of aberrations when the surface distance d28 is made by 0.2 mm larger than the design value;

FIG. 8 is a figure in a sectional view showing the configuration adopted in an optical system according to a third example in an infinity-distance object in-focus state;

FIG. 9(a) is a figure showing various types of aberrations occurring at the optical system according to the third example in an infinity-distance object in-focus state, and FIG. 9(b) is a figure showing a lateral aberration in a vibration-proofing state;

FIG. 10(a) is a figure showing various types of aberrations occurring at the optical system according to the third example when the surface distance d29 is made by 0.2 mm larger than the design value, and FIG. 10(b) is a figure showing various types of aberrations when the surface distance d27 is made by 0.2 mm larger than the design value;

FIG. 11 is a figure in a sectional view showing the configuration adopted in an optical system according to a fourth example in an infinity-distance object in-focus state;

FIG. 12(a) is a figure showing various types of aberrations occurring at the optical system according to the fourth example in an infinity-distance object in-focus state, and FIG. 12(b) is a figure showing a lateral aberration in a vibration-proofing state;

FIG. 13(a) is a figure showing various types of aberrations occurring at the optical system according to the fourth example when the surface distance d29 is made by 0.2 mm larger than the design value, and FIG. 13(b) is a figure showing various types of aberrations when the surface distance d27 is made by 0.2 mm larger than the design value;

FIG. 14 is a figure showing an optical device provided with an optical system according to an embodiment; and

FIG. 15 is a flowchart illustrating the procedure of a method for adjusting an optical system according to an embodiment.

### DESCRIPTION OF EMBODIMENTS

The following is a description of embodiments of an optical system, an optical device and a method for adjusting the optical system. The optical system according to an embodiment is firstly explained.

The optical system achieved in an embodiment of the present invention comprises a first lens group having a positive refractive power, a second lens group having a negative refractive power and a third lens group, disposed in this order along an optical axis, starting from an object side. The second lens group is movable along the optical axis to achieve focusing from an infinity-distance object to a short-distance object.

This configuration enables the optical system to have both a reduced size and a high level of optical performance while maintaining a long focal distance. With the configuration in which the second lens group is movable along the optical axis when performing focusing from an infinity-distance object to a short-distance object, a focusing lens group can be driven with a small-sized motor unit.

In the optical system achieved in this embodiment adopting this configuration, the third lens group includes a vibration-proofing lens group that is movable in a direction having a component perpendicular to the optical axis to achieve image surface correction for image blurring.

This configuration makes it possible to correct misalignment of the optical axis when vibration occurs as caused by, for instance, camera shake and thus improve image forming performance.

In the optical system achieved in this embodiment adopting this configuration, the third lens group includes an adjustment lens group that is disposed closer to the image side than the vibration-proofing lens group is, that includes a negative lens Ln and a lens group having a positive refractive power disposed next to the negative lens Ln, and that is capable of adjusting an air gap between the negative lens Ln and the lens group having a positive refractive power.

Adopting this configuration makes it possible to readily correct various types of aberrations occurring due to manufacturing errors in a short process of operation after the optical system is assembled.

In the optical system in the embodiment, it is desirable that the lens group having a positive refractive power in the adjustment lens group be a lens group G3adjA having a positive refractive power disposed on the image side of the negative lens Ln.

Adopting this structure will make it possible to readily correct various types of aberrations generated due to manufacturing errors in a short process of operation after the optical system is assembled. In particular, this structure will assure good correction of astigmatism.

Furthermore, in the optical system in the embodiment, it is desirable that the lens group having a positive refractive power in the adjustment lens group be a lens group G3adjB having a positive refractive power disposed on the object side of the negative lens Ln.

Adopting this structure will make it possible to readily correct various types of aberrations generated due to manufacturing errors in a short process of operation after the optical system is assembled. In particular, this structure will assure good correction of spherical aberration.

Furthermore, in the optical system in the embodiment, it is desirable that the lens group having a positive refractive power in the adjustment lens group be constituted with the lens group G3adjA having a positive refractive power disposed on the image side of the negative lens Ln and the lens group having a positive refractive power G3adjB disposed on the object side of the negative lens Ln.

Adopting this structure will make it possible to readily correct various types of aberrations generated due to manufacturing errors in a short process of operation after the optical system is assembled. In particular, this structure will assure good correction of astigmatism and spherical aberration.

It is desirable that the lens group G3adjA in the optical system in the embodiment be constituted with one positive lens.

Adopting this structure will assure good correction of astigmatism caused by manufacturing errors and enable the optical system to have a reduced size.

In the optical system in the embodiment, it is desirable that the lens group G3adjB be constituted with at most two lenses.

Adopting this structure will assure good correction of spherical aberration caused by manufacturing errors and enable the optical system to have a reduced size.

Furthermore, in the optical system in the embodiment, it is desirable that the lens group G3adjB be constituted with one positive lens or a combination of one positive lens and one negative lens.

Adopting this structure will assure good correction of spherical aberration caused by manufacturing errors and enable the optical system to have a reduced size.

In the optical system in the embodiment, it is desirable that the negative lens Ln have a bi-concave form.

Adopting this structure will assure good correction of various types of aberrations, in particular astigmatism and spherical aberration.

It is desirable that the optical system in the embodiment satisfy a conditional expression (1) below:

3.0<f/fRA<15.0 (1)

where:

f: the focal length of the optical system in whole; and

fRA: a combined focal length of the lens group G3adjA through a lens located closest to the image side.

The conditional expression (1) above defines a ratio of a focal length of the optical system in whole to a combined focal length of the lens group G3adjA through the lens located closest to the image side. If a value corresponding to f/fRA in the conditional expression (1) is above the upper limit value set in the conditional expression (1), the combined focal length of the lens group G3adjA through the lens located closest to the image side is relatively small, an incident angle at which off-axis main light beam enters the lens group G3adjA is relatively large, and higher-order astigmatism occurs. These will make it difficult to perform corrections. In addition, astigmatism sensitivity of air gap is relatively high, so that error in controlling air gap adjustment will cause astigmatism to occur. Note that it is preferable to set the upper limit value in the conditional expression (1) to 13.0 in order to achieve the advantageous effects of the embodiment with reliability. Furthermore, it is preferable to set the upper limit value in the conditional expression (1) to 11.0 in order to achieve the advantageous effects of the embodiment with even further reliability.

On the other hand, if a value corresponding to f/fRA in the conditional expression (1) is below the lower limit value in the conditional expression (1), the combined focal length of the lens group G3adjA through the lens located closest to the image side is relatively large, an angle at which off-axis main light beam enters the lens group G3adjA is relatively small, and astigmatism sensitivity of air gap is relatively low. These will make it difficult to correct astigmatism caused by manufacturing errors. Note that it is preferable to set the lower limit value in the conditional expression (1) to 4.0 in order to achieve advantageous effects of the embodiment with liability. Furthermore, it is preferable to set the lower limit value in the conditional expression (1) to 5.0 in order to achieve advantageous effects of the embodiment with even further reliability.

It is desirable that the optical system in the embodiment satisfy a conditional expression (2) below:

2.0<f/dR<10.0 (2)

where:

f: the focal length of the optical system in whole; and

dR: a distance measured on the optical axis from the lens surface located closest to the object side of the lens group G3adjA to an image surface.

The conditional expression (2) above defines a ratio of the focal length of the optical system in whole to the distance measured on the optical axis from the lens surface located closest to the object side of the lens group G3adjA to the image surface. If a value corresponding to f/dR in the conditional expression (2) is above the upper limit value in the conditional expression (2), the height of main light beam passing the lens group G3adjA is reduced and astigmatism sensitivity of air gap is relatively low. These will make it difficult to correct astigmatism caused by manufacturing errors. Note that it is preferable to set the upper limit value in the conditional expression (2) to 8.0 in order to achieve advantageous effects of the embodiment with reliability. Furthermore, it is preferable to set the upper limit value of the conditional expression (2) to 7.0 in order to achieve advantageous effects of the embodiment with even further reliability.

On the other hand, if a value corresponding to f/dR in the conditional expression (2) is below the lower limit value of the conditional expression (2), the height of main light beam passing the lens group G3adjA is increased, and higher-order astigmatism is generated. This will make it difficult to perform correction thereof. Note that it is preferable to set the lower limit value in the conditional expression (2) to 3.0 in order to achieve advantageous effects of the embodiment with reliability. Furthermore, it is preferable to set the lower limit value in the conditional expression (2) to 4.0 in order to achieve advantageous effects of the embodiment with even further reliability.

It is desirable that the optical system in the embodiment satisfy a conditional expression (3) below:

0.10<f/−fFA<1.00 (3)

where:

f: the focal length of the optical system in whole; and

fFA: a combined focal length of a lens located closest to the object side through the negative lens Ln.

The conditional expression (3) defines a ratio of the focal length of the optical system in whole to the combined focal length of a lens located closest to the object side through the negative lens Ln. If a value corresponding to f/−fFA in the conditional expression (3) is above the upper limit value in the conditional expression (3), the combined focal length of the lens located closest to the object side through the negative lens Ln tends to be relatively small and fRA, i.e., the combined focal length of the lens located closest to the object side through the negative lens Ln tends to be relatively large, an incident angle at which an off-axis main light beam enters the lens group G3adjA is relatively small, astigmatism sensitivity of air gap is relatively low, and it becomes difficult to correct astigmatism caused by manufacturing errors. Note that it is preferable to set the upper limit value in the conditional expression (3) to 0.90 in order to achieve advantageous effects of the embodiment with reliability. Furthermore, it is preferable to set the upper limit value in the conditional expression (3) to 0.80 in order to achieve advantageous effects of the embodiment with even further reliability.

On the other hand, if a value corresponding to f/−fFA in the conditional expression (3) is below the lower limit value in the conditional expression (3), the combined focal length of the lens located closest to the object side through the negative lens Ln is relatively large, the height of an on-axis light beam that enters the lens group G3adjA is increased, and when astigmatism that is caused by manufacturing errors is corrected by adjusting gaps, spherical aberration will occur secondarily. Note that it is preferable to set the lower limit value in the conditional expression (3) to 0.20 in order to achieve advantageous effects of the embodiment with reliability. Furthermore, it is preferable to set the upper limit value in the conditional expression (3) to 0.30 in order to achieve advantageous effects of the embodiment with even further reliability.

It is desirable that the optical system in the embodiment satisfy conditional expressions (4) and (5) below, together:

|R1A−R2A|/f<0.050 (4)

0.010<(R1A+R2A)/f<0.600 (5)

where:

R1A: a radius of curvature at a lens surface on the image side of the negative lens Ln:

R2A: a radius of curvature at a lens surface on the object side of the lens group G3adjA; and

f: the focal length of the optical system in whole.

The conditional expression (4) defines a ratio of, a difference between the radius of curvature at a surface on the object side and the radius of curvature at a surface on the image side of an air lens sandwiched by the negative lens Ln and the lens group G3adjA, to the focal length of the optical system in whole. The conditional expression (5) defines a ratio of, a sum of the radius of curvature at the surface on the object side and the radius of curvature at the surface on the image side of the air lens sandwiched by the negative lens Ln and the lens group G3adjA, to the focal length of the optical system in whole.

If the conditional expression (4) is satisfied and a value corresponding to (R1A+R2A)/f in the conditional expression (5) is above the upper limit value in the conditional expression (5), both the radius of curvature at the lens surface on the image side of the negative lens Ln and the radius of curvature at the lens surface on the object side of the lens group G3adjA are relatively large, astigmatism sensitivity of air gap is relatively low. These will make it difficult to correct the astigmatism caused by manufacturing errors. Note that it is preferable to set the upper limit value in the conditional expression (4) to 0.040 in order to achieve advantageous effects in the embodiment with reliability. Furthermore, it is preferable to set the upper limit value in the conditional expression (4) to 0.035 in order to achieve advantageous effects in the embodiment with even further reliability. In addition, it is preferable to set the upper limit value in the conditional expression (5) to 0.500 in order to achieve advantageous effects in the embodiment with reliability. Furthermore, it is preferable to set the upper limit value in the conditional expression (5) to 0.450 in order to achieve advantageous effects in the embodiment with even further reliability.

On the other hand, if the conditional expression (4) is satisfied and a value corresponding to (R1A+R2A)/f in the conditional expression (5) is below the lower limit value in the conditional expression (5), both the radius of curvature at the lens surface on the image side of the negative lens Ln and the radius of curvature at the lens surface on the object side surface of the lens group G3adjA are relatively small and higher-order astigmatism occurs. These will make it difficult to perform corrections. Furthermore, astigmatism sensitivity of air gap is relatively high, and astigmatism will occur due to errors in controlling air gap adjustment. Note that it is preferable to set the lower limit value in the conditional expression (5) to 0.050 in order to achieve advantageous effects with reliability. Furthermore, it is preferable to set the lower limit value in the conditional expression (5) to 0.100 in order to achieve advantageous effects with even further reliability.

It is desirable that the optical system in the embodiment satisfy a conditional expression (6) below:

0.005<IIIA/IA·(y/f)² (6)

where:

IIIA: the sum of coefficients of third-order astigmatism from the lens group G3adjA to the lens located closest to the image side when the focal length of the optical system in whole is normalized to be 1;

IA: the sum of coefficients of third-order spherical aberration from the lens group G3adjA to the lens located closest to the image side when the focal length of the optical system in whole is normalized to be 1;

y: a maximum image height of the optical system; and

f: the focal length of the optical system in whole.

The conditional expression (6) defines a ratio of, the sum of coefficients of third-order astigmatism from the lens group G3adjA to the lens located closest to the image side when the focal length of the optical system in whole is normalized to be 1, to a product of the sum of coefficients of third-order spherical aberration from the lens group G3adjA to the lens located closest to the image side when the focal length of the optical system in whole is normalized to be 1 and a square of field angle. If a value corresponding to IIIA/1A·(y/f)² in the conditional expression (6) is below the lower limit value in the conditional expression (6), spherical aberration will occur secondarily when astigmatism that is caused by manufacturing errors is corrected by adjusting gaps. Note that it is preferable to set the lower limit value in the conditional expression (6) to 0.015 in order to achieve advantageous effects in the embodiment with reliability. Furthermore, it is preferable to set the lower limit of the conditional expression (6) to 0.025 in order to achieve advantageous effects in the embodiment with even further reliability.

It is desirable that the optical system in the embodiment satisfy a conditional expression (7) below:

0.005<IIIA·(y/f)²<0.060 (7)

where:

IIIA: the sum of coefficients of third-order astigmatism from the lens group G3adjA to the lens located closest to the image side when the focal length of the optical system in whole is normalized to be 1;

y: a maximum image height of the optical system; and

f: the focal length of the optical system in whole.

The conditional expression (7) defines a product of the sum of coefficients of third-order astigmatism from the lens group G3adjA to the lens located closest to the image side when the focal length of the optical system in whole is normalized to be 1 and a square of field angle. If a value corresponding to IIIA·(y/f)² in the conditional expression (7) is above the upper limit value in the conditional expression (7), higher-order astigmatism will occur to make it difficult to perform correction. In addition, astigmatism sensitivity of air gap is relatively high and astigmatism will occur due to errors in controlling air gap adjustment. Note that it is preferable to set the upper limit value in the conditional expression (7) to 0.050 in order to achieve advantageous effects in the embodiment with reliability. Furthermore, it is preferable to set the upper limit value in the conditional expression (7) to 0.040 in order to achieve advantageous effects with even further reliability.

On the other hand, if a value corresponding to IIIA·(y/f)² in the conditional expression (7) is below the lower limit value in the conditional expression (7), astigmatism sensitivity of air gap is relatively low to make it difficult to correct astigmatism caused by manufacturing errors. Note that it is preferable to set the lower limit value in the conditional expression (7) to 0.010 in order to achieve advantageous effects of the embodiment with reliability. Furthermore, it is preferable to set the lower limit value in the conditional expression (7) to 0.020 in order to achieve advantageous effects in the embodiment with even further reliability.

It is desirable that the third lens group in the optical system achieved in the embodiment include the negative lens Ln and the lens group G3adjA with its convex surface facing the object side, adjacently disposed in this order, starting on the object side.

Adopting this structure enables a high level of optical performance to be achieved while allowing air gap to have enough sensitivity to adjust astigmatism.

It is desirable that the optical system in the embodiment satisfy a conditional expression (8) below:

0.001<dM/f<0.010 (8)

where:

dM: a distance along the optical axis of air gap between the negative lens Ln and the lens group G3adjA; and

f: the focal length of the optical system in whole.

The conditional expression (8) defines a ratio of the distance along the optical axis of air gap between the negative lens Ln and the lens group G3adjA to the focal length of the optical system in whole. If a value corresponding to dM/f in the conditional expression (8) is above the upper limit value in the conditional expression (8), higher-order astigmatism will occur to make it difficult to correct it. Note that it is preferable to set the upper limit value in the conditional expression (8) to 0.008 in order to achieve advantageous effect in the embodiment with reliability. Furthermore, it is preferable to set the upper limit value in the conditional expression (8) to 0.007 in order to achieve advantageous effects in the embodiment with even further reliability.

On the other hand, if a value corresponding to dM/f in the conditional expression (8) is below the lower limit value in the conditional expression (8), it is difficult to constitute stable lens holding members, manufacturing errors increase and astigmatism occurs. Note that it is preferable to set the lower limit value in the conditional expression (8) to 0.002 in order to achieve advantageous effects in the embodiment with reliability. Furthermore, it is preferable to set the lower limit value in the conditional expression (8) to 0.003 in order to achieve advantageous effects in the embodiment with even further reliability.

In the optical system in the embodiment, it is desirable that the negative lens Ln be held by a first holding member and that the lens group G3adjA be held by a second holding member.

Adopting this structure makes it possible to readily adjust air gap for correcting astigmatism caused by manufacturing errors.

It is desirable that the air gap between the negative lens Ln and the lens group G3adjA in the optical system in the embodiment be adjusted by varying the number of gap adjustment members disposed as sandwiched between the first holding member and the second holding member.

Adopting this structure makes it possible to readily adjust air gap for correcting astigmatism caused by manufacturing errors.

It is desirable that the optical system in the embodiment satisfy a conditional expression (9) below:

1.00<f/fFB<2.70 (9)

where:

f: the focal length of the optical system in whole; and

fFB: a combined focal length of the lens located closest to the object side through the lens group G3adjB.

The conditional expression (9) defines a ratio of the focal length of the optical system in whole to the combined focal length of the lens located closest to the object side through the lens group G3adjB. If a value corresponding to f/fFB in the conditional expression (9) is above the upper limit value in the conditional expression (9), the combined focal length of the lens located closest to the object side through the lens group G3adjB is relatively small, the incident angle at which a light beam on the optical axis enters the negative lens Ln is relatively small, spherical aberration sensitivity of air gap is relatively low. These will make it difficult to correct the spherical aberration caused by manufacturing errors. Note that it is preferable to set the upper limit value in the conditional expression (9) to 2.55 in order to achieve advantageous effects with reliability. Furthermore, it is preferable to set the upper limit value in the conditional expression (9) to 2.45 in order to achieve advantageous effects with even further reliability.

On the other hand, if a value corresponding to f/fFB in the conditional expression (9) is below the lower limit value in the conditional expression (9), the combined focal length of the lens located closest to the object side through the lens group G3adjB is relatively large, the incident angle at which a light beam on the optical axis enters the negative lens Ln is relatively large, spherical aberration sensitivity of air gap is relatively high, and spherical aberration will occur due to errors in controlling in air gap adjustment. Note that it is preferable to set the lower limit value in the conditional expression (9) to 1.20 in order to achieve advantageous effects in the embodiment with reliability. Furthermore, it is preferable to set the lower limit value in expression condition (9) to 1.30 in order to achieve advantageous effects in the embodiment with even further reliability.

It is describable that the optical system in the embodiment satisfy a conditional expression (10) below:

0.0050<dSA/f<0.0500 (10)

where:

dSA: a distance along the optical axis of air gap between the lens group G3adjB and the negative lens Ln; and

f: the focal length of the optical system in whole.

The conditional expression (10) defines a ratio of, the distance along the optical axis of air gap between the lens group G3adjB and the negative lens Ln, to the focal length of the optical system in whole. If a value corresponding to dSA/f in the conditional expression (10) is above the upper limit value in the conditional expression (10), higher-order spherical aberrations will occur to make it difficult to correct it. Note that it is preferable to set the upper limit in the conditional expression (10) to 0.0300 in order to achieve advantageous effects in the embodiment with reliability. Furthermore, it is preferable to set the upper limit in the conditional expression (10) to 0.0265 in order to achieve advantageous effects in the embodiment with even further reliability.

On the other hand, if a value corresponding to dSA/f in the conditional expression (10) is below the lower limit value in the conditional expression (10), it is difficult to construct stable lens holding members, manufacturing errors increase, and spherical aberration will occur. Note that it is preferable to set the lower limit value in the conditional expression (10) to 0.0070 in order to achieve advantageous effects in the embodiment. Furthermore, it is preferable to set the lower limit value in the conditional expression (10) to 0.0085 in order to achieve advantageous effects in the embodiment with even further reliability.

It is desirable that the optical system in the embodiment satisfy a conditional expression (11) below:

1.3<f/−fRB<6.5 (11)

where:

f: the focal length of the optical system in whole; and

fRB: a combined focal length of the negative lens Ln through the lens located closest to the image side.

The conditional expression (11) defines a ratio of the focal length of the optical system in whole to the combined focal length of the negative lens Ln through the lens located closest to the image side. If a value corresponding to f/−fRB in the conditional expression (11) is above the upper limit value in the conditional expression (11), the combined focal length of the negative lens Ln through the lens located closest to the image side is relatively small, the height of a light beam along the optical axis passing the negative lens Ln is relatively small, and spherical aberration sensitivity of air gap is relatively low. These will make it difficult to correct spherical aberration caused by manufacturing errors. Note that it is preferable to set the upper limit value in the conditional expression (11) to 6.3 in order to achieve advantageous effects with reliability. Furthermore, it is preferable to set the upper limit value in the conditional expression (11) to 6.1 to achieve advantageous effects with even further reliability.

On the other hand, if a value corresponding to f/−fRB in the conditional expression (11) is below the lower limit value in the conditional expression (11), the combined focal length of the negative lens Ln through the lens located closest to the image side is relatively small, the height of a light beam on the optical axis passing the negative lens Ln is relatively large, the spherical aberration sensitivity of air gap is relatively high, and spherical aberration will occur due to errors in controlling air gap adjustment. Note that it is preferable to set the lower limit in the conditional expression (11) to 1.5 in order to achieve advantageous effects in the embodiment with reliability. Furthermore, it is preferable to set the lower limit value in the conditional expression (11) to 1.6 in order to achieve advantageous effects in the embodiment with even further reliability.

It is desirable that the optical system in the embodiment satisfy conditional expressions (12) and (13), together:

|R1B−R2B|/f<0.150 (12)

0.150<(R1B+R2B)/f<0.500 (13)

where:

R1B: a radius of curvature at a lens surface on the image side of the lens group G3adjB;

R2B: a radius of curvature at a lens surface on the object side of the negative lens Ln; and

f: the focal length of the optical system in whole.

The conditional expression (12) defines a ratio of, a difference between the radius of curvature at the surface on the object side and the radius of curvature at the surface on the image side of an air lens sandwiched between the lens group G3adjB and the negative lens Ln, to the focal length of the optical system in whole. The conditional expression (13) defines a ratio of, a sum of the radius of curvature at the surface on the object side and the radius of curvature at the surface on the image side of the air gap sandwiched between the lens group G3adjB and the negative lens Ln, to the focal length of the optical system in whole.

If the conditional expression (12) is satisfied and a value corresponding to (R1B+R2B) in the conditional expression (13) is above the upper limit value in the conditional expression (13), both the radius of curvature at the surface on the image side of the lens group G3adjB and the radius curvature at the surface on the object side of the negative lens Ln are relatively large, spherical aberration sensitivity of the air gap is relatively low. These will make it difficult to correct spherical aberration caused by manufacturing errors. Note that it is preferable to set the upper limit value in the conditional expression (12) to 0.120 in order to achieve advantageous effects in the embodiment with reliability. Furthermore, it is preferable to set the upper limit in the conditional expression (12) to 0.110 in order to achieve advantageous effects in the embodiment with even further reliability. In addition, it is preferable to set the upper limit of the conditional expression in (13) to 0.470 in order to achieve advantageous effects in the embodiment with reliability. Furthermore, it is preferable to set the upper limit value in the conditional expression (13) to 0.455 in order to achieve advantageous effects in the embodiment with even further reliability.

On the other hand, if the conditional expression (12) is satisfied and a value corresponding to (R1B+R2B)/f in the conditional expression (13) is below the lower limit value in expression (13), both the radius of curvature at the surface on the image side of the lens group G3adjB and the radius of curvature at the surface on the object side of the negative lens Ln relatively are small, higher-order spherical aberrations occur. These will make it difficult to make corrections. In addition, the spherical aberration sensitivity of air gap is relatively high, and spherical aberration occurs due to errors in controlling air gap adjustment. Note that it is preferable to set the lower limit value in the conditional expression (13) to 0.200 in order to achieve advantageous effects in the embodiment with reliability. Furthermore, it is desirable to set the lower limit value in the conditional expression (13) to 0.225 in order to achieve advantageous effects in the embodiment with even further reliability.

It is desirable that the optical system in the embodiment satisfy a conditional expression (14):

IIIB/IB·(y/f)²<0.010 (14)

where:

IIIB: a sum of coefficients of third-order astigmatism from the negative lens Ln to the lens located closest to the image side when the focal length of the optical system in whole is normalized to be 1;

IB: a sum of coefficients of third-order spherical aberration from the negative lens Ln to the lens located closest to the image side when the focal length of the optical system in whole is normalized to be 1;

y: a maximum image height of the optical system; and

f: the focal length of the optical system in whole.

The conditional expression (14) defines a ratio of, the sum of coefficients of third-order astigmatism from the negative lens Ln to the lens located closest to the image side when the focal length of the optical system in whole is normalized to be 1, to a product of the sum of coefficients of third-order spherical aberration from the negative lens Ln to the lens located closest to the image side when the focal length of the optical system in whole is normalized to be 1 and a square of field angle. If a value corresponding to IIIB/IB·(y/f)² in the conditional expression (14) is above the upper limit value in the conditional expression (14), astigmatism occurs secondarily when the spherical aberration that is caused by manufacturing errors is corrected by adjusting gaps. Note that it is preferable to set the upper limit value in the conditional expression (14) to 0.007 in order to achieve advantageous effects in the embodiment with reliability. Furthermore, it is preferable to set the upper limit value in the conditional expression (14) to 0.004 in order to achieve advantageous effects with even further reliability.

It is desirable that the optical system in the embodiment satisfy a conditional expression (15) below:

1.20<−IB<4.70 (15)

where:

IB: a sum of coefficients of third-order spherical aberration from the negative lens Ln to the lens located closest to the image side when the focal length of the optical system in whole is normalized to be 1.

The conditional expression (15) defines the sum of coefficients of third-order spherical aberration from the negative lens Ln to the lens located closest to the image side when the focal length of the optical system in whole is normalized to be 1. If a value corresponding to −IB in the conditional expression (15) is above the upper limit value in the conditional expression (15), higher-order spherical aberrations occur, which will make it difficult to perform corrections thereof. In addition, the spherical aberration sensitivity of air gap is relatively high and spherical aberration will occur due to errors in controlling air gap adjustment. Note that it is preferable to set the upper limit in the conditional expression (15) to 4.5 in order to achieve advantageous effects in the embodiment with reliability. Furthermore, it is preferable to set the upper limit value in the conditional expression (15) to 4.4 in order to achieve advantageous effects in the embodiment with even further reliability.

On the other hand, if a value corresponding to −IB in the conditional expression (15) is below the lower limit value in the conditional expression (15), the spherical aberration sensitivity of air gap is relatively low and it will become difficult to correct the spherical aberration caused by manufacturing errors. Note that it is preferable to set the lower limit value in the conditional expression (15) to 1.4 in order to achieve advantageous effects in the embodiment with reliability. Furthermore, it is preferable to set the lower limit value in the conditional expression (15) to 1.45 in order to achieve advantageous effects in the embodiment with even further reliability.

It is desirable that the third lens group in the optical system achieved in the embodiment comprises the lens group G3adjB with its convex surface facing the image side and the negative lens Ln, adjacently disposed in this order starting on the object side.

Adopting this structure enables high level of optical performance to be achieved while allowing sensitivity of air gap to be enough to adjust spherical aberration.

It is desirable that in the optical system in the embodiment the negative lens Ln be held by a first holding member and the lens group G3adjB be held by a third holding member.

Adopting this structure enables the adjustment of air gap for correcting the spherical aberration caused by manufacturing errors to be achieved with ease.

It is desirable that the air gap between the negative lens Ln and the lens group G3adjB in the optical system in the embodiment be adjusted by varying the number of interval adjustment members disposed as sandwiched between the first holding member and the third holding member.

Adopting this structure enables the adjustment of air gap for correcting the spherical aberration caused by manufacturing errors to be achieved with ease.

It is desirable that in the optical system in the embodiment, the negative lens Ln be held by the first holding member, the lens group G3adjA be held by the second holding member, and the lens group G3adjB be held by the third holding member.

Adopting this structure enables the air gap adjustment for correcting astigmatism caused by manufacturing errors and the air gap adjustment for correcting the spherical aberration to be achieved with ease.

In the optical system in the embodiment, it is desirable that the air gap between the negative lens Ln and the lens group G3adjA be adjusted by varying the number of gap adjustment members disposed as sandwiched between the first holding member and the second holding member and the air gap between the negative lens Ln and the lens group G3adjB be adjusted by varying the number of gap adjustment members disposed as sandwiched between the first holding member and the third holding member.

Adopting this structure enables the air gap adjustment for correcting the astigmatism caused by manufacturing errors and the air gap adjustment for correcting the spherical aberration to be achieved with ease.

It is desirable that the optical system in the embodiment satisfy a conditional expression (16) below:

0.20<TL3/f1<0.50 (16)

where:

TL3: a distance along the optical axis from the lens surface of the third lens group located closest to the object side to the lens surface of the third lens group located closest to the image side; and

f1: the focal length of the first lens group.

The conditional expression (16) defines a ratio of, the distance along the optical axis from the lens surface of the third lens group located closest to the object side to the lens surface of the third lens group located closest to the image side, i.e., the length of the third lens group on the optical axis, to the focal length of the first lens group. If a value corresponding to TL3/f1 in the conditional expression (16) is above the upper limit value in the conditional expression (16), the focal length of the first lens group is relatively small, the magnification relative to the focal length of the first lens group is relatively large. These will make it difficult to correct a second-order chromatic aberration. Note that it is preferable to set the upper limit value in the conditional expression (16) to 0.40 in order to achieve advantageous effects in the embodiment with reliability. Furthermore, it is preferable to set the upper limit value in the conditional expression (16) to 0.36 in order to achieve advantageous effects with even further reliability.

On the other hand, if a value corresponding to TL3/f1 in the conditional expression (16) is below the lower limit value in the conditional expression (16), the length of the third lens group along the optical axis is relatively small, which makes it difficult to construct stable lens holding members, and manufacturing errors increase. These will cause astigmatism to occur. Note that it is preferable to set the lower limit value in the conditional expression (16) to 0.25 in order to achieve advantageous effects in the embodiment. Furthermore, it is preferable to set the lower limit value in the conditional expression (16) to 0.28 in order to achieve advantageous effects in the embodiment with even further reliability.

It is desirable that the optical system in the embodiment satisfy a conditional expression (17) below:

0.65<TL/f<1.15 (17)

where:

TL: a distance on the optical axis from the lens surface located closest to the object side in the optical system in whole to the image surface; and

f: the focal length of the optical system in whole.

The conditional expression (17) defines a ratio of, the distance on the optical axis from the lens surface located closest to the object side in the optical system in whole to the image surface, that is, the total length of the optical system, to the focal length of the optical system in whole. If a value corresponding to TL/f in the conditional expression (17) is above the upper limit value in the conditional expression (17), the amount of peripheral light is relatively small, and if the position of the entrance pupil is shifted forward to make correction, it will be difficult to correct the distortion. Note that it is preferable to set the upper limit value in the conditional expression (17) to 1.10 in order to achieve advantageous effects in the embodiment with reliability. Furthermore, it is preferable to set the upper limit value in the conditional expression (17) to 1.05 in order to achieve advantageous effects in the embodiment with even further reliability.

On the other hand, if a value corresponding to TL/f in the conditional expression (17) is below the lower limit value in the conditional expression (17), it is difficult to correct both the second-order chromatic aberration occurring on the optical axis and the second-order chromatic aberration occurring off the optical axis. Note that it is preferable to set the lower limit value in the conditional expression (17) to 0.70 in order to achieve advantageous effects with reliability. Furthermore, it is preferable to set the lower limit value in the conditional expression (17) to 0.75 in order to achieve advantageous effects in the embodiment with even further reliability.

It is desirable that the optical system in the embodiment satisfy a conditional expression (18) below:

0.30<f/f12<1.00 (18)

where:

f: the focal length of the optical system in whole; and

f12: a combined focal length of the first lens group and the second lens group in an infinity-distance object in-focus state.

The conditional expression (18) defines a ratio of the focal length of the optical system in whole to the combined focal length of the first lens group and the second lens group in an infinity-distance object in-focus state. If a value corresponding to f/f12 in the conditional expression (18) is above the upper limit value in the conditional expression (18), the combined focal length of the first lens group and the second lens group in an infinity-distance object in-focus state is relatively small. This will make it difficult to correct the second-order chromatic aberration. Note that it is preferable to set the upper limit value in the conditional expression (18) to 0.90 in order to achieve advantageous effects in the embodiment with reliability. Furthermore, it is preferable to set the upper limit value in the conditional expression (18) to 0.85 in order to achieve advantageous effects in the embodiment with even further reliability.

On the other hand, if a value corresponding to f/f12 in the conditional expression (18) is below the lower limit value in the conditional expression (18), the combined focal length of the first lens group and the second lens group in an infinity-distance object in-focus state is relatively large, and the focal length of the second lens group is relatively small. These will increase the astigmatism in a short-distance object in-focus state. Note that it is preferable to set the lower limit value in the conditional expression (18) to 0.35 in order to achieve advantageous effects in the embodiment with reliability. Furthermore, it is preferable to set the lower limit value in the conditional expression (18) to 0.40 in order to achieve advantageous effects in the embodiment with even further reliability.

It is desirable that the optical system in the embodiment perform focusing from an infinity-distance object to a short-distance object by moving the second lens group along the optical axis toward the image side.

Adopting this structure enables a small-sized optical system to be achieved and fluctuations of the spherical aberration, chromatic aberration, and astigmatism to be corrected well to achieve a high level of optical performance.

An optical device in the embodiment includes the above-mentioned optical system. Adopting this structure enables an optical device to be achieved, which is provided with an optical system whose various types of aberrations caused by manufacturing errors can be corrected in a short process of operation after the optical system is assembled.

A method for adjusting an optical system in the embodiment is a method for adjusting an optical system that includes a first lens group having a positive refractive power, a second lens group having a negative refractive power, and a third lens group, disposed in this order along the optical axis, starting on the object side, wherein the second lens group is movable along the optical axis to perform focusing from an infinity-distance object to a short-distance object, the third lens group includes a vibration-proofing lens group that performs image surface correction for image blurring, by being moved in a direction having a component perpendicular to the optical axis, and wherein the third lens group further includes an adjustment lens group that is disposed closer to the image side than the vibration-proofing lens group is, that includes a negative lens Ln and a lens group having a positive refractive power disposed next to the negative lens Ln, and that is capable of adjusting an air gap between the negative lens Ln and the lens group having a positive refractive power.

Such a method for adjusting the optical system enables various types of aberrations caused by manufacturing errors to be corrected with ease in a short process of operation after the optical system is assembled.

### NUMERICAL EXAMPLES

The following is a description, given in reference to the attached drawings, of the optical systems according to the present invention, achieved in examples in conjunction with specific numerical values.

### First Example

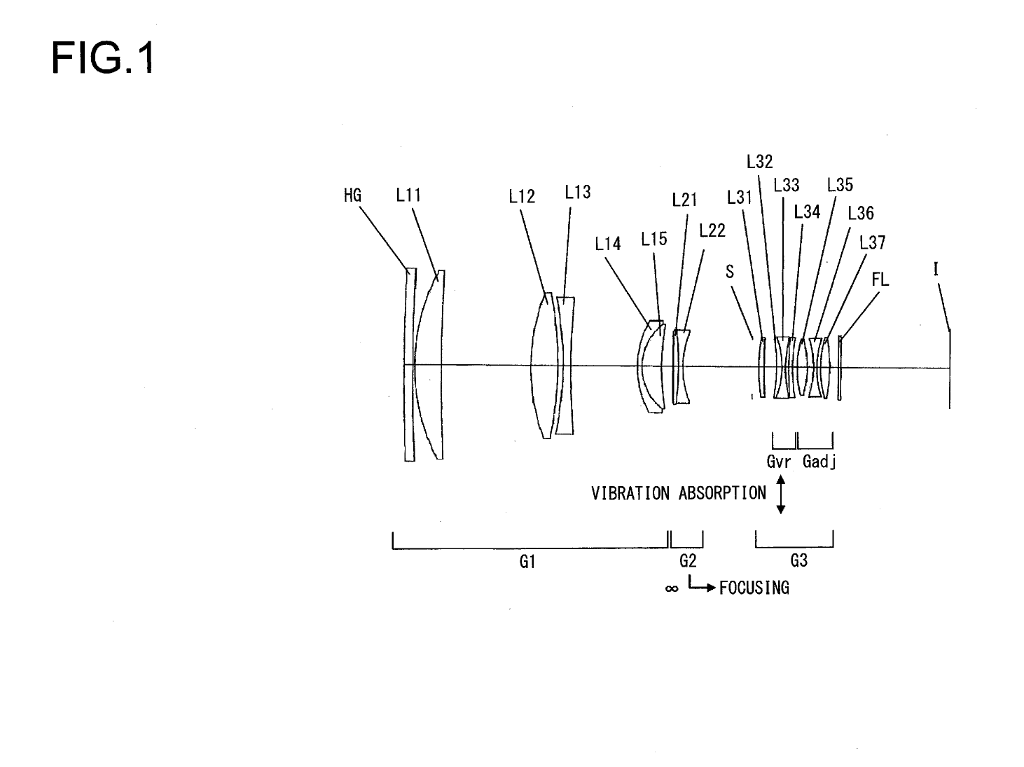

FIG. 1 illustrates a configuration adopted in an optical system in the first example of the present invention.

As shown in FIG. 1, the optical system in the example is constituted with a first lens group G1 having a positive refractive power, a second lens group G2 having a negative refractive power, an aperture stop S, and a third lens group G3 having a positive refractive power, disposed in this order along the optical axis, starting on the object side.

The first lens group G1 is constituted with a protective filter glass HG with its convex surface facing the objet side having a considerably weak refractive power, a positive meniscus lens L11 with its convex surface facing the object side, a bi-convex lens L12, a bi-concave lens L13, and a cemented lens constituted with a negative meniscus lens L14 with its convex surface facing the object side and a positive meniscus lens L15 with its convex surface facing the object side, disposed along the optical axis in this order, starting on the object side.

The second lens group G2 is constituted with a cemented lens constituted with a bi-convex lens L21 and a bi-concave lens L22, disposed along the optical axis in this order, starting on the object side.

The third lens group G3 is constituted with a positive meniscus lens L31 with tis convex surface facing the object side, a cemented lens constituted with a positive meniscus lens L32 with its concave surface facing the object side and a bi-concave lens L33, a negative meniscus lens L34 with its convex surface facing the object side, a bi-convex lens L35, a bi-concave lens L36, and a bi-convex lens L37.

A filter FL, such as a low pass filter, is arranged at an image surface I side of the third lens group G3.

On the image surface I is arranged an image sensor (not shown) constituted with, for instance, a CCD, a CMOS, or the like.

The optical system in the example having adopted this structure enables focusing from an infinity-distance object to a short-distance object to be performed by moving the second lens group G2 as a focusing lens group toward the image surface I side. Also, image surface correction is performed on image blurring, i.e., vibration absorption is performed, by moving a vibration-proofing lens group Gvr including the cemented lens constituted with the positive meniscus lens L32 and the bi-concave lens L33 and the negative meniscus lens L34 in a direction having a component perpendicular to the optical axis to shift an image on the image surface I.

In the optical system in the example, the bi-convex lens L35, the bi-concave lens L36, and the bi-convex lens L37 constitute an adjustment lens group Gadj for assuring good correction of degradation of image forming performance caused by manufacturing errors, after the optical system is assembled.

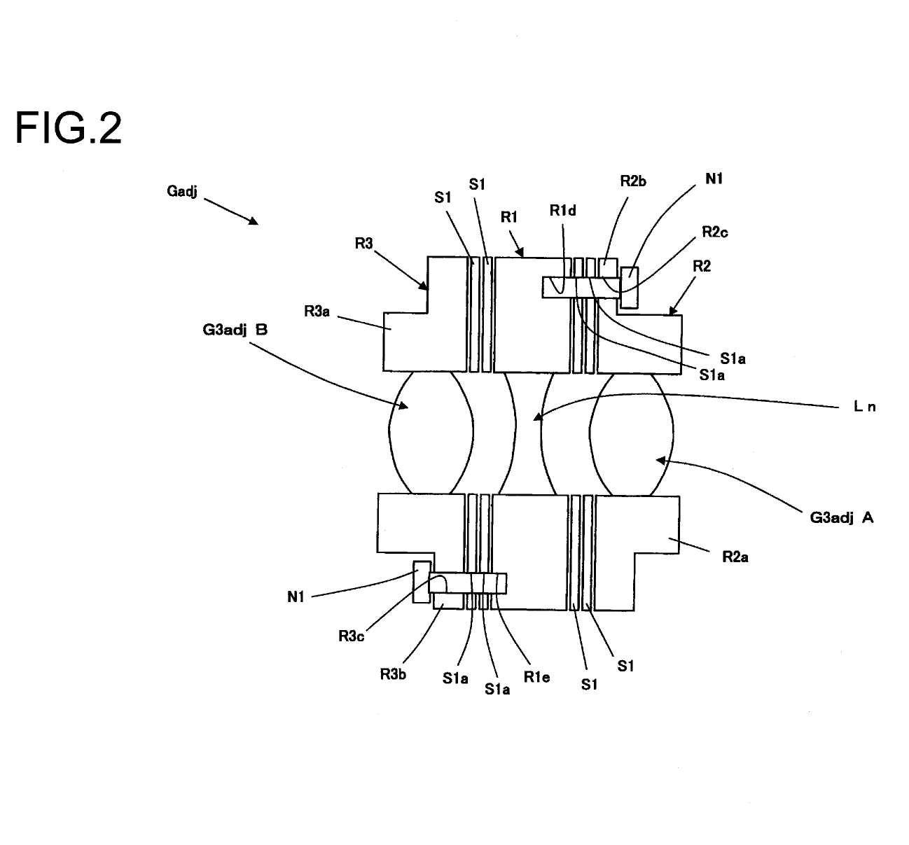

Next, the adjustment lens group Gadj is explained. FIG. 2 is a figure showing an enlarged sectional view of an adjustment mechanism of the adjustment lens group Gadj. As shown in FIG. 2, the adjustment lens group Gadj is constituted with a bi-concave negative lens Ln, a lens group G3adjA having a positive refractive power adjacently disposed at the image surface I side of the negative lens Ln, and a lens group G3adjB having a positive refractive power adjacently disposed at the object side of the negative lens Ln. In this example, the bi-concave lens L36 corresponds to the negative lens Ln, the bi-convex lens L37 corresponds to the lens group G3adjA, and the bi-convex lens L35 corresponds to the lens group G3adjB. Note that the adjustment lens group Gadj being constituted with the bi-concave negative lens Ln, the lens group G3adjA having a positive refractive power adjacently disposed at the image surface I side of the negative lens Ln, and the lens group G3adjB having a positive refractive power adjacently disposed at the object side of the negative lens Ln; and the adjustment mechanism and the adjustment method each explained next, are commonly adopted in each of the following examples.

As shown in FIG. 2, the negative lens Ln is held by a first annular lens holding frame R1, the lens group G3adjA is held by a second annular lens holding frame R2, and the lens group G3adjB is held by a third annular lens holding frame R3. The second lens holding frame R2 has a cylinder part R2a that holds the lens group G3adjA and a flange part R2b that is provided on the object side end of the cylinder part R2a extending outwardly in a radial direction. The size of the outer diameter of the flange part R2b and the size of the outer diameter of the first lens holding frame R1 are made equivalent to each other. The third lens holding frame R3 has a cylinder part R3a that holds the lens group G3adjB and a flange part R3b provided on the image surface I side end of the cylinder part R3a extending outwardly in a radial direction. The size of the outer diameter of the flange part R3b and the size of the outer diameter of the first lens holding frame R1 are mage equivalent to each other.

The flange part R2b of the second lens holding frame R2 is formed of three screw holes R2c extending through the flange part R2b in the direction of the optical axis at substantially equally spaced intervals in a circumferential direction. The flange part R3b of the third lens holding frame R3 is formed of three screw holes R3c extending through the flange part R3b in the direction of the optical axis at substantially equal intervals in the circumferential direction. The first lens holding frame R1 is formed of three screw holes R1d extending in the direction of the optical axis and opening at its surface on the image surface I side, i.e., at its surface facing the flange part R2b of the second lens holding frame R2 so as to correspond to the three screw holes R2c in the flange part R2b at substantially equal intervals in the circumferential direction. In addition, the first lens holding frame R1 is formed of three screw holes R1e extending in the direction of the optical axis and opening at its surface on the object side, i.e., at its surface facing the flange part R3b of the third lens holding frame R3 so as to correspond to the three screw holes R3c of the flange part R3b at substantially equal intervals in the circumferential direction. The three screw holes R1d and the three scree holes R1e in the first lens holding frame R1 are formed such that they are arranged alternately in the circumferential direction at substantially equal intervals as seen from the direction of optical axis.

The distance between the first lens holding frame R1 and the second lens holding frame R2 can be adjusted by varying the number of gap adjustment members S1, which are annular plate-like members, disposed as sandwiched between the first lens holding frame R1 and the second lens holding frame R2. Moreover, the distance between the first lens holding frame R1 and the third lens holding frame R3 can be adjusted by varying the number of interval adjustment members S1, which are annular plate-like members, disposed as sandwiched between the first lens holding frame R1 and the third lens holding frame R3.

The gap adjustment members S1 each have a size of the outer diameter that is equivalent to the size of the outer diameter of the first lens holding frame R1. The gap adjustment members S1 are each formed of six screw holes S1a at substantially equal intervals in the circumferential distance. Adopting this structure allows the gap adjustment members S1 to be disposed between the first lens holding frame R1 and the second lens holding frame R2 and also between the first lens holding frame R1 and the third lens holding frame R3.

The first lens holding frame R1, the second lens holding frame R2, and the gap adjustment members S1 disposed between the first lens holding frame R1 and the second lens holding frame R2 are fixed to each other with three screws N1. More particularly, three screws N1, which are threadably mounted on three screw holes R2c, respectively, in the flange part R2b of the second lens holding frame R2 from the image surface I side, extend through respective screw holes R2c and respective screw holes S1a in the gap adjustment members S1 that correspond to respective screw holes R2c and are threadably mounted on corresponding screw holes R1d. With this structure, the first lens holding frame R1, the second lens holding frame R2, and the gap adjustment members S1 are fixed to each other. In the example, as shown in FIG. 2, two gap adjustment members S1 are inserted and fixed between the first lens holding frame R1 and the second lens holding frame R2.

Similarly, three screws N1, which are threadably mounted on three screw holes R3c, respectively, in the flange part R3b of the third lens holding frame R3 from the object side, extend through respective screw holes R3c and through respective screw holes S1a in the gap adjustment members S1 that correspond to respective screw holes R3c and are threadably mounted on corresponding screw holes R1e in the first lens holding frame R1. With this structure, the first lens holding frame R1, the third lens holding frame R3, and the gap adjustment members S1 are fixed to each other. In the example, as shown in FIG. 2, two gap adjustment members S1 are inserted and fixed between the first lens holding frame R1 and the third lens holding frame R3.

And the optical system in the example allows the number of the gap adjustment members S1 that are disposed between the first lens holding frame R1 and the second lens holding frame R2 to be varied after the three screws N1 on the second lens holding frame R2 side are unfastened and removed. And after the number of the gap adjustment members S1 is varied, the three screws N1 are again fastened tightly on the second lens holding frame R2 to fix the first lens holding frame R1, the second lens holding frame R2, and a varied number of the gap adjustment members S1 to each other to achieve adjustment of the gap between the first lens holding frame R1 and the second lens holding frame R2. By adjusting the gap between the first lens holding frame R1 and the second lens holding frame R2 in this manner, the air gap between the negative lens Ln and the lens group G3adjA can be adjusted. That is, in the example, the air gap between the bi-concave lens L36 and the bi-convex lens L37 can be adjusted.

Similarly, the number of the gap adjustment members S1 that are disposed between the first lens holding frame R1 and the third lens holding frame R3 can be varied after the three screws N1 on the third lens group R3 side are unfastened and removed. And after the number of the gap adjustment members S1 is varied, the three screws N1 are again fastened tightly on the third lens group R3 to fix the first lens holding frame R1, the third lens holding frame R3, and a varied number of the gap adjustment members S1 to each other to achieve adjustment of the gap between the first lens holding frame R1 and the third lens holding frame R3. By adjusting the gap between the first lens holding frame R1 and the third lens holding frame R3 in this manner, the air gap between the negative lens Ln and the lens group G3adjB can be adjusted. That is, in the example, the air gap between the bi-concave lens L36 and the bi-convex lens L35 can be adjusted.

Table 1 below lists data values pertaining to the optical system achieved in the example.

In [Overall Specifications] in Table 1, “f” indicates the focal length, “FNO” indicates the F number, “2ω” indicates the field angle (unit: “°”), “Y” indicates the maximum image height, “TL” indicates the total length of the optical system (i.e., the distance on the optical axis from the first surface to the image surface I in an infinity-distance object in-focus state), and “BF” indicates the back focus (i.e., the distance on the optical axis from the lens surface located closest to the image side to the image surface I). “Air converted TL” indicates a value obtained by measuring the distance on the optical axis from the first surface to the image surface I in an infinity-distance object in-focus state in a state where an optical block, such as a filter, has been removed from the optical path. “Air converted BF” indicates a value obtained by measuring the distance on the optical axis from the lens surface of a rear lens group GR located closest to the image side to the image surface I in a state where an optical block, such as a filter, has been removed from the optical path.

In [Surface Data], “surface number” indicates the order with which a given optical surface is located, counting from the object side, “r” indicates the radius of curvature, “d” indicates a surface distance (the distance between an nth surface (n is an integer) and an (n+1)th surface), “nd” indicates the refractive index at the d-line (wavelength 587.6 nm), and “νd” indicates the Abbe number at the d-line (wavelength 587.6 nm). In addition, “object surface” indicates an object surface, “variable” indicates a variable surface distance, “aperture S” indicates the aperture stop S, and “image surface” indicates the image surface I. The radius of curvature R=∞ means a flat surface. The refractive index nd=1.000000 of air is not included in the table.

In [Variable Distance Data], “f” indicates the focal length, “β” indicates a photographic magnification factor, and “di” (i is an integer) indicates a surface distance between an nth surface (n is an integer) and an (n+1)th surface. In addition, “d0” indicates a distance from the objet to the lens surface located closest to the object side.

[Lens Group Data] shows a starting number and a focal length of each lens group.

[Values Corresponding to Conditional Expressions] shows values corresponding to variable terms in respective conditional expressions.

Here, the focal length f, the radius of curvature r, and other lengths described in Table 1 are expressed in unit of “mm”. However, the unit is not limited to “mm” since optical systems will provide equivalent optical performance when they are proportionally expanded or proportionally reduced.

Note that the reference symbols in Table 1 described above are also applicable in Tables in subsequent examples as well.

TABLE 1
First Example
[Overall Specifications]

| | |
|---|---|
| f | 294.00 |
| FNO | 2.91 |
| 2ω | 8.32 |
| Y | 21.60 |
| TL | 305.39 |
| Air converted TL | 304.88 |
| BF | 67.25 |
| Air converted BF | 66.74 |

[Surface Data]

| Surface Number | r | d | nd | νd |
|---|---|---|---|---|
| Object Surface | ∞ | | | |
| 1) | 1200.3704 | 5.00 | 1.51680 | 63.88 |
| 2) | 1199.7897 | 1.00 | | |
| 3) | 117.0888 | 15.00 | 1.43385 | 95.25 |
| 4) | 1140.8744 | 50.00 | | |
| 5) | 118.6010 | 15.00 | 1.43385 | 95.25 |
| 6) | −219.4076 | 3.00 | | |
| 7) | −195.8561 | 4.50 | 1.61266 | 44.46 |
| 8) | 456.3056 | 37.52 | | |
| 9) | 56.5844 | 2.50 | 1.61772 | 49.81 |
| 10) | 31.2731 | 11.00 | 1.49782 | 82.57 |
| 11) | 143.8239 | (variable) | | |
| 12) | 1196.9976 | 3.00 | 1.84666 | 23.78 |
| 13) | −223.3874 | 2.40 | 1.76684 | 46.78 |
| 14) | 54.5722 | (variable) | | |
| 15) | ∞ | 3.50 (aperture) | | |
| 16) | 117.0936 | 3.00 | 1.88300 | 40.66 |
| 17) | 337.7034 | 7.02 | | |
| 18) | −106.4501 | 3.00 | 1.80100 | 34.92 |
| 19) | −48.8669 | 1.90 | 1.49782 | 82.57 |
| 20) | 70.8719 | 2.00 | | |
| 21) | 265.8882 | 1.90 | 1.49782 | 82.57 |
| 22) | 88.2775 | 2.77 | | |
| 23) | 63.5637 | 5.50 | 1.62299 | 58.12 |
| 24) | −67.1168 | 3.50 | | |
| 25) | −63.8865 | 2.00 | 1.80100 | 34.92 |
| 26) | 55.1040 | 2.00 | | |
| 27) | 64.5295 | 5.00 | 1.81600 | 46.59 |
| 28) | −109.1205 | 5.00 | | |
| 29) | ∞ | 1.50 | 1.51680 | 63.88 |
| 30) | ∞ | 60.75 | | |
| Image surface | ∞ | | | |

[Variable Distance Data]

| | Infinite | Close-up Shooting Distance |
|---|---|---|
| forβ | 293.997 | −0.183 |
| d0 | ∞ | 1594.607 |
| d11 | 6.441 | 22.206 |
| d14 | 38.692 | 22.927 |

[Lens Group Data]

| Group | Starting Surface | f |
|---|---|---|
| 1 | 1 | 177.78 |
| 2 | 12 | −73.17 |
| 3 | 16 | 187.92 |

[Values Corresponding to Conditional Expressions]

```
  (1) f/fRA = 5.8
  (2) f/dR = 4.1
  (3) f/−fFA = 0.36
  (4) |R1A − R2A|/f = 0.032
  (5) (R1A + R2A)/f = 0.41
  (6) IIIA/IA · (y/f)² = 0.040
  (7) IIIA · (y/f)² = 0.030
  (8) dM/f = 0.007
  (9) f/fFB = 1.5
(10) dSA/f = 0.012
(11) f/−fRB = 1.6
(12) |R1B − R2B|/f = 0.011
(13) (R1B + R2B)/f = 0.45
(14) IIIB/IB · (y/f)² = 0.001
(15) −IB = 1.494
(16) TL3/f1 = 0.31
(17) TL/f = 1.04
(18) f/f12 = 0.55
```

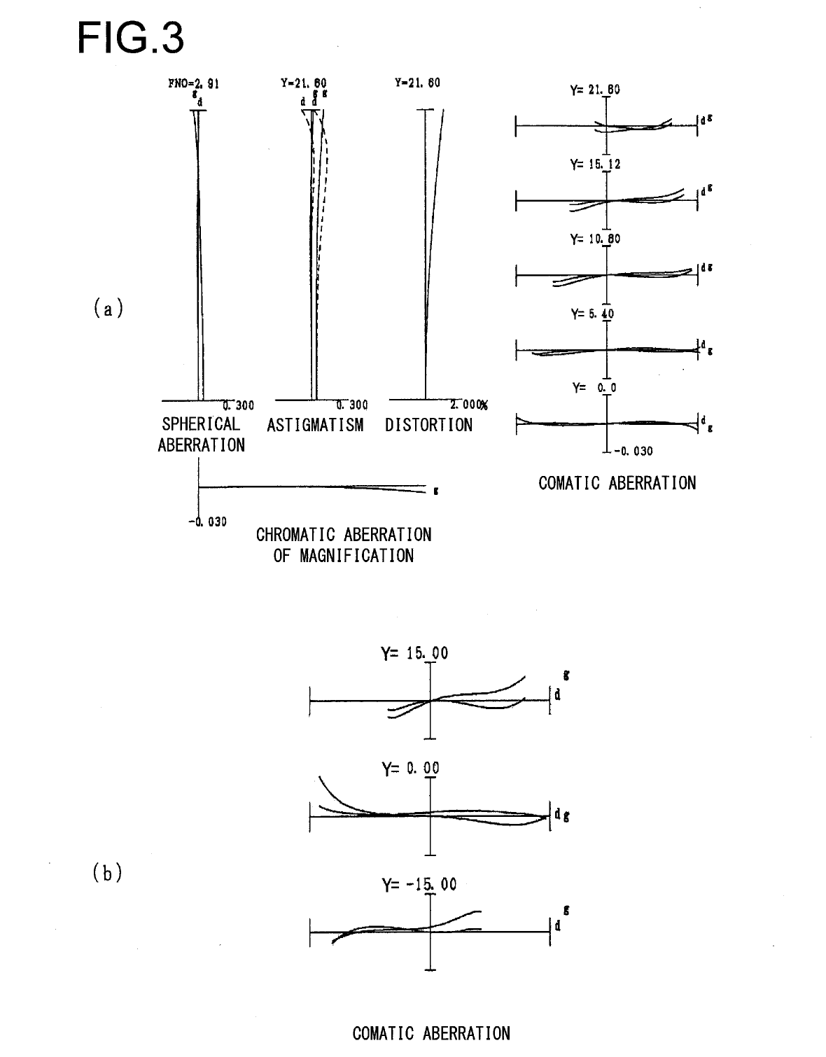

FIG. 3(a) is a figure showing various types of aberrations occurring at the optical system in the first example in an infinity-distance object in-focus state and FIG. 3(b) is a figure showing a lateral aberration in a vibration-proofing state.

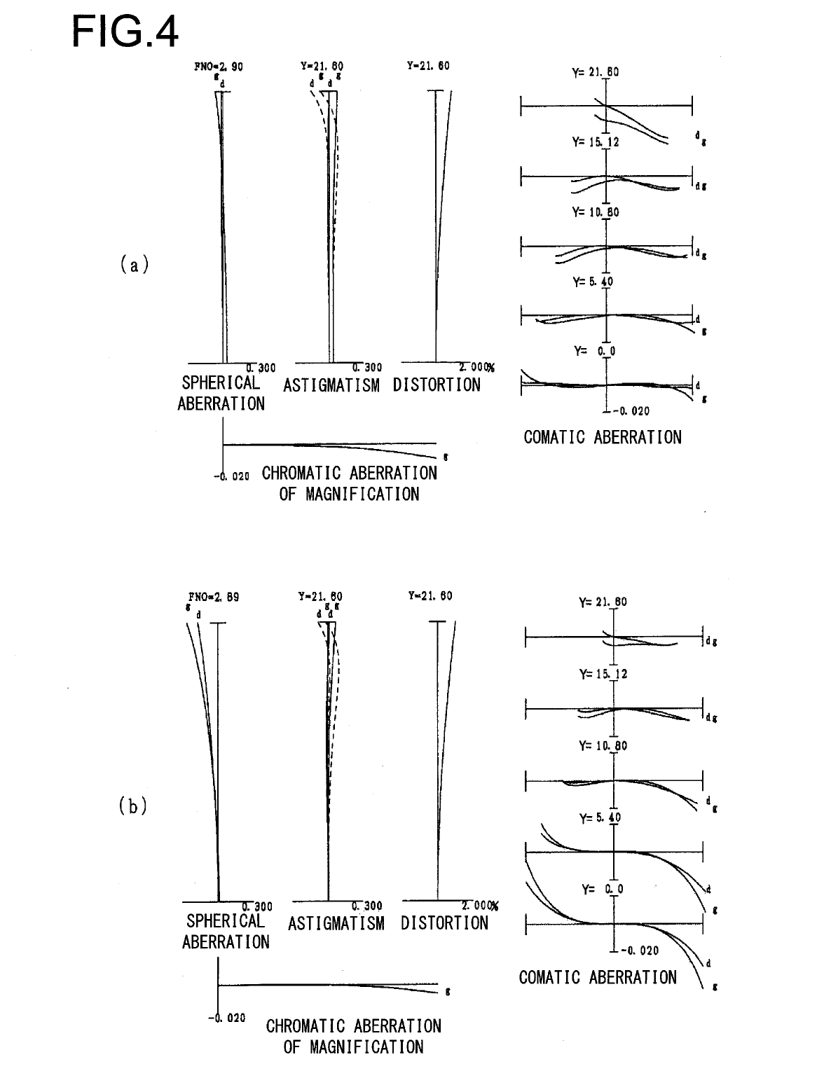

FIG. 4(a) is a figure showing various types of aberrations occurring at the optical system in the first example when the surface distance d26 is made by 0.2 mm larger than the design value and FIG. 4(b) is a figure showing various types of aberrations when the surface distance d24 is made by 0.2 mm larger than the design value.

In each aberration diagram, “FNO” indicates F number and “Y” indicates image height. In addition, in the figure, “d” indicates an aberration diagram at d-line (wavelength λ=587.6 nm) and “g” indicates an aberration diagram at g-line (wavelength λ=435.8 nm), and those without marks indicate aberration diagrams at d-line. In the spherical aberration diagram, a value of the F number that corresponds to the maximum aperture is shown. In the astigmatism diagram and distortion diagram, maximum values of image height are shown, respectively. In the comatic aberration diagrams, various values of image height are shown. The aberration diagrams relating to comatic aberrations show meridional comatic aberrations at d-line and g-line, respectively. In the aberration diagram showing astigmatism, the solid line indicates a sagittal image surface and the broken line indicates a meridional image surface. Note that in various types of aberration diagrams in the following examples, the same reference symbols as those used in the example are used.

As will be apparent from the aberration diagrams in FIG. 3(a) and FIG. 3(b), respectively, the optical system in the first example will assure good correction of various types of aberrations and has excellent image forming performance.

In addition, from FIG. 4(a), it can be seen that astigmatism is shifted to be negative and the aberration caused by manufacturing errors can be corrected. Also, from FIG. 4(b), it can be seen that the spherical aberration is shifted to be negative and the aberration caused by manufacturing errors can be corrected.

### Second Example

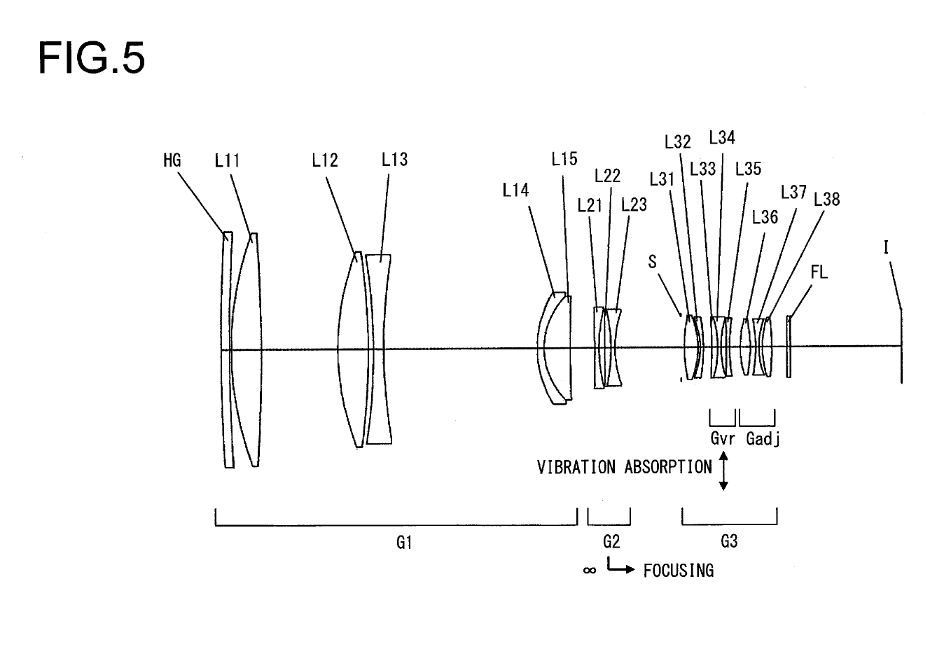

FIG. 5 is a figure showing a sectional view of the structure of the optical system in a second example.

As shown in FIG. 5, the optical system in the example is constituted with a first lens group G1 having a positive refractive power, a second lens group G2 having a negative refractive power, an aperture stop S, and a third lens group having a positive refractive power, disposed in this order along the optical axis, starting on the object side.

The first lens group G1 is constituted with a protective filter glass HG having a considerably weak refractive power with its convex surface facing the objet side, a bi-convex lens L11, a bi-convex lens L12, a bi-concave lens L13, and a cemented lens constituted with a negative meniscus lens L14 with its convex surface facing the object side and a positive meniscus lens L15 with its convex surface facing the object side, disposed along the optical axis in this order, starting on the object side.

The second lens group G2 is constituted with a bi-concave lens L21 and a cemented lens constituted with a positive meniscus lens L22 with its concave surface facing the object side and a bi-concave lens L23, disposed along the optical axis in this order, starting on the object side.

The third lens group G3 is constituted with a bi-convex lens L31, a negative meniscus lens L32 with its concave surface facing the object side, a cemented lens constituted with a positive meniscus lens L33 with its concave surface facing the object side and a bi-concave lens L34, a bi-concave lens L35, a bi-convex lens L36, a bi-concave lens L37, and a bi-convex lens L38, disposed along the optical axis in this order, starting on the object side.

At the image surface I side of the third lens group G3 is disposed a filter FL, such as a low pass filter.

On the image surface I is disposed an image sensor (not shown) that is constituted with a CCD, a CMOS, or the like.

The optical system in the example adopting this structure allows focusing from an infinity-distance object to a short-distance object to be achieved by moving the second lens group G2 serving as a focusing lens group toward the image surface I side. Also, the image surface correction on image blurring, i.e., vibration absorption, is performed by moving a vibration-proofing lens group Gvr, which includes the cemented lens constituted with the positive meniscus lens L33 and the bi-concave lens L34, and the negative meniscus lens L35, in a direction having a component perpendicular to the optical axis to shift an image on the image surface I.

In the optical system in the example, the bi-convex lens L36, the bi-concave lens L37, and the bi-convex lens L38 constitute an adjustment lens group Gadj for assuring good correction of degradation of image forming performance due to manufacturing errors after the optical system is assembled.

Similarly to the first example, the adjustment lens group Gadj is constituted with a bi-concave negative lens Ln, a lens group G3adjA having a positive refractive power adjacently disposed at the image surface I side of the negative lens Ln, and a lens group G3adjB having a positive refractive power adjacently disposed at the object side of the negative lens Ln (see FIG. 2). In this example, the bi-concave lens L37 corresponds to the negative lens Ln, the bi-convex lens L38 corresponds to the lens group G3adjA, and the bi-convex lens L36 corresponds to the lens group G3adjB. The air gap adjustment mechanism for adjusting the air gap between the negative lens Ln and the lens group G3adjA and the air gap adjustment mechanisms for adjusting the air gap between the negative lens Ln and the lens group G3adjB are similar to those adopted in the first example.

Table 2 below lists data values pertaining to the optical system achieved in the example.

TABLE 2
Second Example
[Overall Specifications]

| | |
|---|---|
| f | 391.99 |
| FNO | 2.88 |
| 2ω | 6.27 |
| Y | 21.60 |
| TL | 398.99 |
| Air converted TL | 398.31 |
| BF | 75.99 |
| Air converted BF | 75.31 |

[Surface Data]

| Surface Number | r | d | nd | νd |
|---|---|---|---|---|
| Object Surface | ∞ | | | |
| 1) | 1200.3704 | 5.00 | 1.51680 | 63.88 |
| 2) | 1199.7897 | 1.00 | | |
| 3) | 206.0123 | 17.50 | 1.43385 | 95.25 |
| 4) | −1124.1029 | 45.00 | | |
| 5) | 162.1697 | 18.00 | 1.43385 | 95.25 |
| 6) | −424.1506 | 3.00 | | |
| 7) | −387.2326 | 6.00 | 1.61266 | 44.46 |
| 8) | 341.3405 | 90.05 | | |
| 9) | 66.3028 | 4.00 | 1.79500 | 45.31 |
| 10) | 45.2667 | 15.50 | 1.49782 | 82.57 |
| 11) | 852.5142 | (variable) | | |
| 12) | −1364.8500 | 2.50 | 1.81600 | 46.59 |
| 13) | 100.3113 | 3.45 | | |
| 14) | −1478.6561 | 3.50 | 1.84666 | 23.80 |
| 15) | −115.0000 | 2.40 | 1.51823 | 58.82 |
| 16) | 70.0000 | (variable) | | |
| 17) | ∞ | 2.00 (aperture) | | |
| 18) | 94.2086 | 8.00 | 1.58313 | 59.42 |
| 19) | −52.4800 | 1.20 | | |
| 20) | −50.2830 | 1.90 | 1.90200 | 25.26 |
| 21) | −107.9165 | 5.00 | | |
| 22) | −308.3841 | 3.50 | 1.84666 | 23.80 |
| 23) | −67.5239 | 1.90 | 1.59319 | 67.90 |
| 24) | 63.3602 | 3.10 | | |
| 25) | −502.9890 | 1.90 | 1.75500 | 52.34 |
| 26) | 112.1269 | 6.26 | | |
| 27) | 61.9176 | 5.80 | 1.79504 | 28.69 |
| 28) | −93.9603 | 3.20 | | |
| 29) | −91.9469 | 1.90 | 1.84666 | 23.80 |
| 30) | 49.5642 | 2.00 | | |
| 31) | 60.5211 | 5.50 | 1.79952 | 42.09 |
| 32) | −162.0287 | 9.00 | | |
| 33) | ∞ | 2.00 | 1.51680 | 63.88 |
| 34) | ∞ | 64.99 | | |
| Image Surface | ∞ | | | |

[Variable Distance Data]

| | Infinite | Close-up Shooting Distance |
|---|---|---|
| forβ | 391.990 | −0.173 |
| d0 | ∞ | 2201.000 |
| d11 | 14.478 | 29.909 |
| d16 | 38.472 | 23.041 |

[Lens Group Data]

| Group | Starting Surface | f |
|---|---|---|
| 1 | 1 | 179.21 |
| 2 | 12 | −70.56 |
| 3 | 18 | 165.78 |

[Values Corresponding to Conditional Expressions]

```
  (1) f/fRA = 7.0
  (2) f/dR = 4.8
  (3) f/−fFA = 0.39
  (4)|R1A − R2A|/f = 0.028
  (5) (R1A + R2A)/f = 0.27
  (6) IIIA/IA · (y/f)² = 0.040
  (7) IIIA · (y/f)² = 0.026
  (8) dM/f = 0.005
  (9) f/fFB = 1.6
(10) dSA/f = 0.009
(11) f/−fRB = 2.7
(12) |R1B − R2B|/f = 0.016
(13) (R1B + R2B)/f = 0.45
(14) IIIB/IB · (y/f)² = 0.002
(15) −IB = 1.464
(16) TL3/f1 = 0.35
(17) TL/f = 1.02
(18) f/f12 = 0.43
```

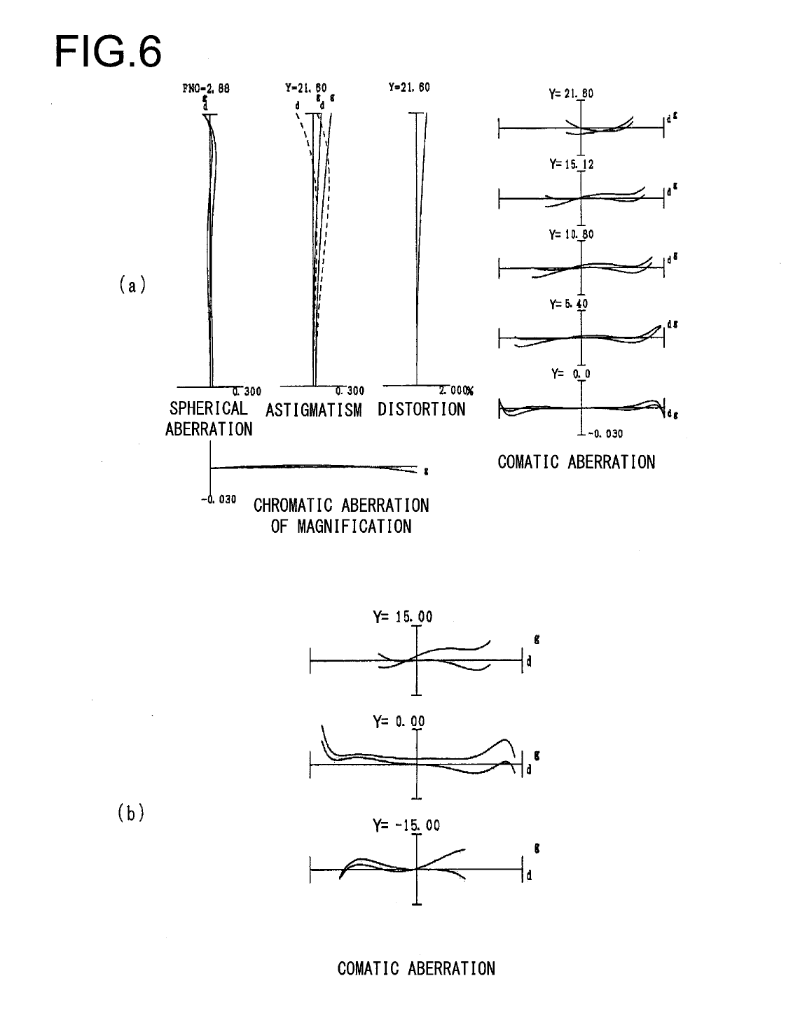

FIG. 6(a) is a figure showing various types of aberrations occurring at the optical system in the second example in an infinity-distance object in-focus state and FIG. 6(b) is a figure showing a lateral aberration in a vibration-proofing state.

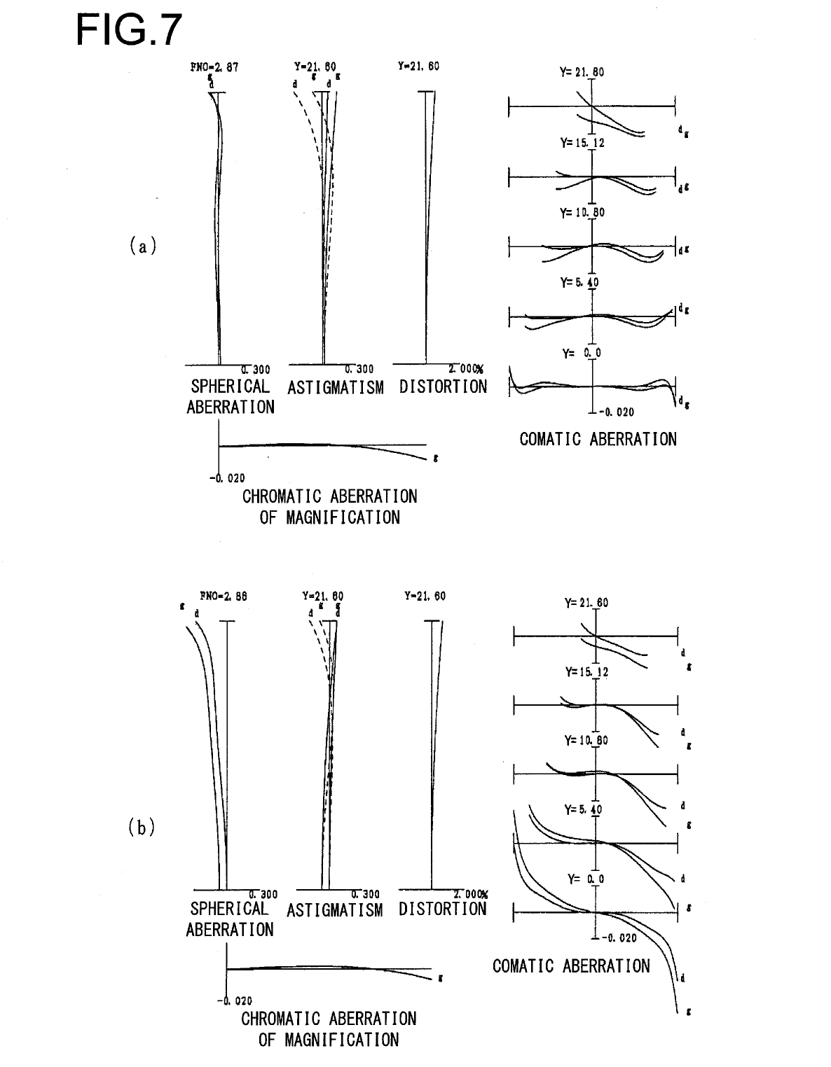

FIG. 7(a) is a figure showing various types of aberrations occurring at the optical system in the second example when the surface distance d30 is made by 0.2 mm larger than the design value and FIG. 7(b) is a figure showing various types of aberrations when the surface distance d28 is made by 2 mm larger than the design value.

As will be apparent from FIGS. 6(a) and 6(b), it can be seen that the optical system pertaining to the second example will assure good correction of various types of aberrations and has excellent image forming performance.

Also, it is apparent from FIG. 7(a) that the astigmatism is shifted to be negative and the aberration caused by manufacturing errors can be corrected.

Also, it is apparent from FIG. 7(b) that the spherical aberration is shifted to be negative and the aberrations caused by manufacturing errors can be corrected.

### Third Example

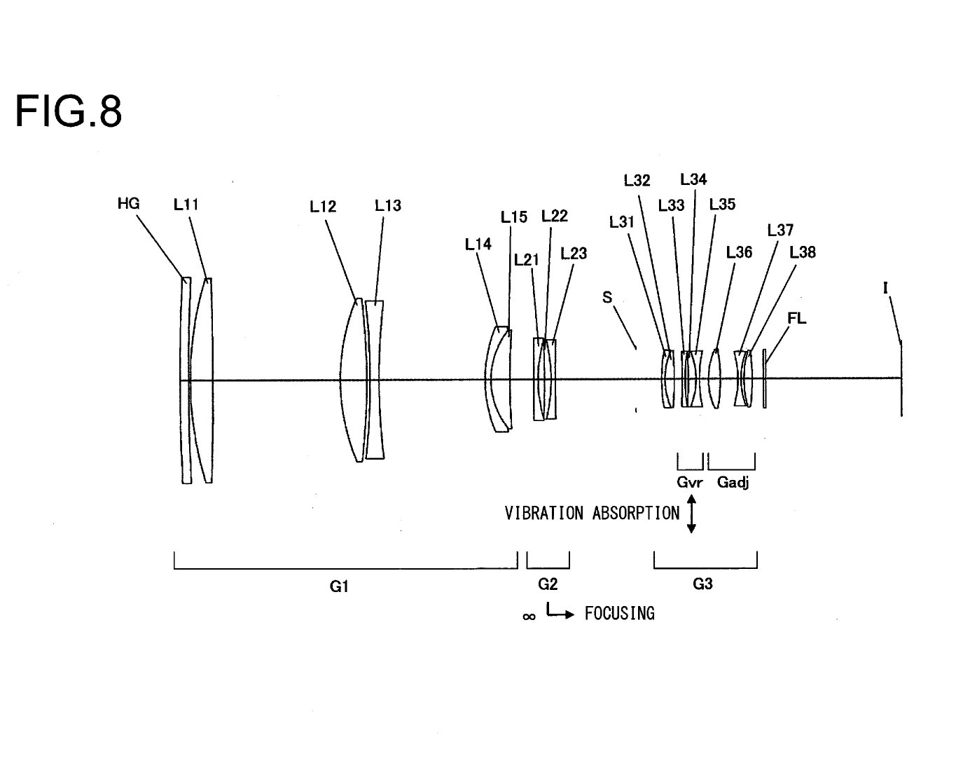

FIG. 8 is a figure showing the structure of the optical system in a third example in a sectional view.

As shown in FIG. 8, the optical system in the example is constituted with a first lens group G1 having a positive refractive power, a second lens group G2 having a negative refractive power, an aperture stop S, and a third lens group having a positive refractive power, disposed in this order along the optical axis, starting on the object side.

The first lens group G1 is constituted with a protective filter glass HG having a considerably weak refractive power with its convex surface facing the objet side, a bi-convex lens L11, a bi-convex lens L12, a bi-concave lens L13, and a cemented lens constituted with a negative meniscus lens L14 with its convex surface facing the object side and a positive meniscus lens L15 with its convex surface facing the object side, disposed in this order along the optical axis, starting on the object side.

The second lens group G2 is constituted with a bi-concave lens L21 and a cemented lens constituted with a positive meniscus lens L22 with its concave surface facing the object side and a bi-concave lens L23, disposed in this order along the optical axis, starting on the object side.

The third lens group G3 is constituted with a cemented lens that is constituted with a negative meniscus lens L31 with its convex surface facing the object side and a bi-concave lens L32, a bi-concave lens L33, a cemented lens that is constituted with a positive meniscus lens L34 with its concave surface facing the object side and a bi-concave lens L35, a bi-convex lens L36, a bi-concave lens L37, and a bi-convex lens L38, disposed in this order along the optical axis, starting on the object side.

At the image surface I side of the third lens group G3 is disposed a filter FL, such as a low pass filter.

On the image surface I is disposed an image sensor (not shown) that is constituted with a CCD, a CMOS, or the like.

The optical system in the example having adopted this construction allows focusing from an infinity-distance object to a short-distance object to be achieved by moving the second lens group G2 serving as a focusing lens group toward the image surface I side. Also, the image surface correction on image blurring, that is, vibration absorption, is achieved by moving a vibration-proofing lens group Gvr, which includes the bi-concave lens L33 and a cemented lens that is constituted with the positive meniscus lens L34 and the bi-concave lens L35, in a direction having a component perpendicular to the optical axis to shift the image on the image surface I.

In the optical system in the example, the bi-convex lens L36, the bi-concave lens L37, and the bi-convex lens L38 constitute an adjustment lens group Gadj for assuring good correction of degradation of image forming performance due to manufacturing errors after the optical system is assembled.

Similarly to the first example, the adjustment lens group Gadj is constituted with a bi-concave negative lens Ln, a lens group G3adjA having a positive refractive power adjacently disposed at the image surface I side of the negative lens Ln, and a lens group G3adjB having a positive refractive power adjacently disposed at the object side of the negative lens Ln (see FIG. 2). In this example, the bi-concave lens L37 corresponds to the negative lens Ln, the bi-convex lens L38 corresponds to the lens group G3adjA, and the bi-convex lens L36 corresponds to the lens group G3adjB. The air gap adjustment mechanism for adjusting the air gap between the negative lens Ln and the lens group G3adjA and the air gap adjustment mechanism for adjusting the air gap between the negative lens Ln and the lens group G3adjB are similar to those in the first example.

Table 3 below lists data values pertaining to the optical system achieved in the example.

TABLE 3
Third Example
[Overall Specifications]

| | |
|---|---|
| f | 490.00 |
| FNO | 4.08 |
| 2ω | 5.02 |
| Y | 21.60 |
| TL | 423.32 |
| Air converted TL | 422.81 |
| BF | 87.50 |
| Air converted BF | 86.99 |

[Surface Data]

| Surface Number | r | d | nd | νd |
|---|---|---|---|---|
| Object Surface | ∞ | | | |
| 1) | 1200.3702 | 5.00 | 1.51680 | 63.88 |
| 2) | 1199.7895 | 1.00 | | |
| 3) | 210.8821 | 13.34 | 1.43385 | 95.25 |
| 4) | −2487.4702 | 75.00 | | |
| 5) | 130.9329 | 15.39 | 1.43385 | 95.25 |
| 6) | −427.0712 | 2.02 | | |
| 7) | −423.8689 | 5.20 | 1.61266 | 44.46 |
| 8) | 390.3283 | 62.39 | | |
| 9) | 82.6869 | 3.50 | 1.69680 | 55.52 |
| 10) | 48.3676 | 11.00 | 1.49782 | 82.57 |
| 11) | 392.6365 | (variable) | | |
| 12) | −4350.1348 | 2.50 | 1.80610 | 40.97 |
| 13) | 87.5905 | 3.78 | | |
| 14) | −440.4557 | 3.80 | 1.80809 | 22.74 |
| 15) | −104.1071 | 2.50 | 1.55298 | 55.07 |
| 16) | 936.7350 | (variable) | | |
| 17) | ∞ | 15.00 (aperture) | | |
| 18) | 93.8232 | 2.00 | 1.80809 | 22.74 |
| 19) | 43.1795 | 5.40 | 1.49782 | 82.57 |
| 20) | −224.8650 | 4.50 | | |
| 21) | −1117.7757 | 1.80 | 1.60300 | 65.44 |
| 22) | 101.2201 | 1.91 | | |
| 23) | −289.4739 | 4.50 | 1.61266 | 44.46 |
| 24) | −44.1719 | 1.80 | 1.49782 | 82.57 |
| 25) | 76.9868 | 5.33 | | |
| 26) | 42.4858 | 7.00 | 1.61266 | 44.46 |
| 27) | −103.0363 | 10.38 | | |
| 28) | −61.4311 | 1.80 | 1.83481 | 42.73 |
| 29) | 46.6607 | 1.77 | | |
| 30) | 62.9569 | 4.80 | 1.80610 | 33.27 |
| 31) | −147.1794 | 6.50 | | |
| 32) | ∞ | 1.50 | 1.51680 | 63.88 |
| 33) | ∞ | 79.50 | | |
| Image Surface | ∞ | | | |

[Variable Distance Data]

| | Infinite | Close-up Shooting Distance |
|---|---|---|
| forβ | 490.000 | −0.152 |
| d0 | ∞ | 3176.002 |
| d11 | 14.048 | 27.486 |
| d16 | 47.375 | 33.937 |

[Lens Group Data]

| Group | Starting Surface | f |
|---|---|---|
| 1 | 1 | 193.27 |
| 2 | 12 | −107.20 |
| 3 | 18 | 736.10 |

[Values Corresponding to Conditional Expressions]

```
  (1) f/fRA = 8.9
  (2) f/dR = 5.3
  (3) f/−fFA = 0.61
  (4) |R1A − R2A|/f = 0.033
  (5) (R1A + R2A)/f = 0.22
  (6) IIIA/IA · (y/f)² = 0.028
  (7) IIIA · (y/f)² = 0.026
  (8) dM/f = 0.004
  (9) f/fFB = 2.2
(10) dSA/f = 0.021
(11) f/−fRB = 5.8
(12) |R1B − R2B|/f = 0.085
(13) (R1B + R2B)/f = 0.34
(14) IIIB/IB · (y/f)² = 0.002
(15) −IB = 4.377
(16) TL3/f1 = 0.32
(17) TL/f = 0.86
(18) f/f12 = 0.79
```

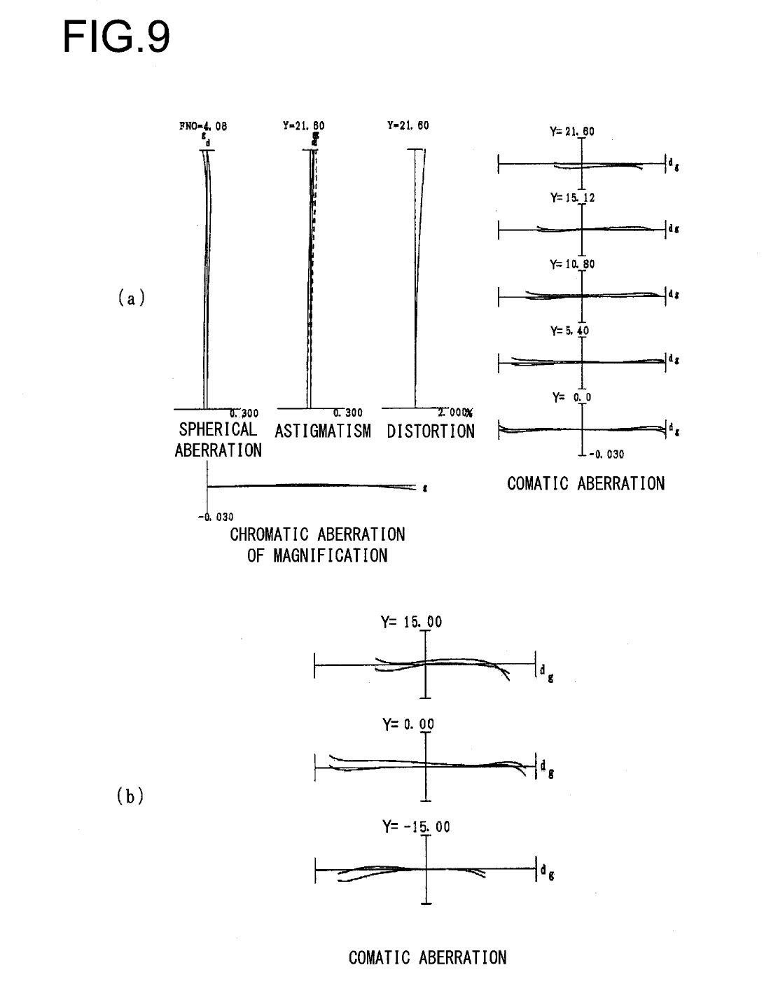

FIG. 9(a) is a figure showing various types of aberrations occurring at the optical system in the third example in an infinity-distance object in-focus state and FIG. 9(b) is a figure showing a lateral aberration in a vibration-proofing state.

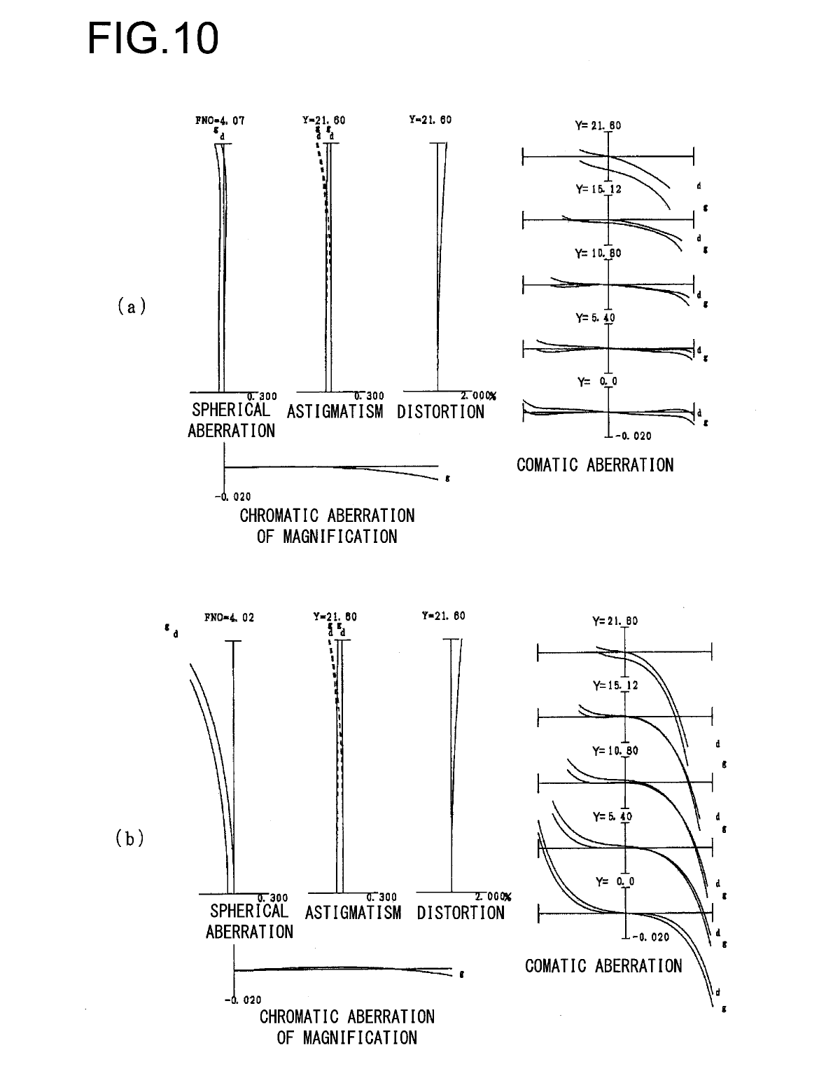

FIG. 10(a) is a figure showing various types of aberrations occurring at the optical system in the third example when the surface distance d29 is made by 0.2 mm larger than the design value and FIG. 10(b) is a figure showing various types of aberrations when the surface distance d27 is made by 0.2 mm larger than the design value.

As will be apparent from the aberration diagrams in FIG. 9(a) and FIG. 9(b), respectively, the optical system in the third example will assure good correction of various types of aberrations and has excellent image forming performance.

In addition, from FIG. 10(a), it can be seen that the astigmatism is shifted to be negative and the aberration caused by manufacturing errors can be corrected.

Also, from FIG. 10(b), it can be seen that the spherical aberration is shifted to be negative and the aberration caused by manufacturing errors can be corrected.

### Fourth Example

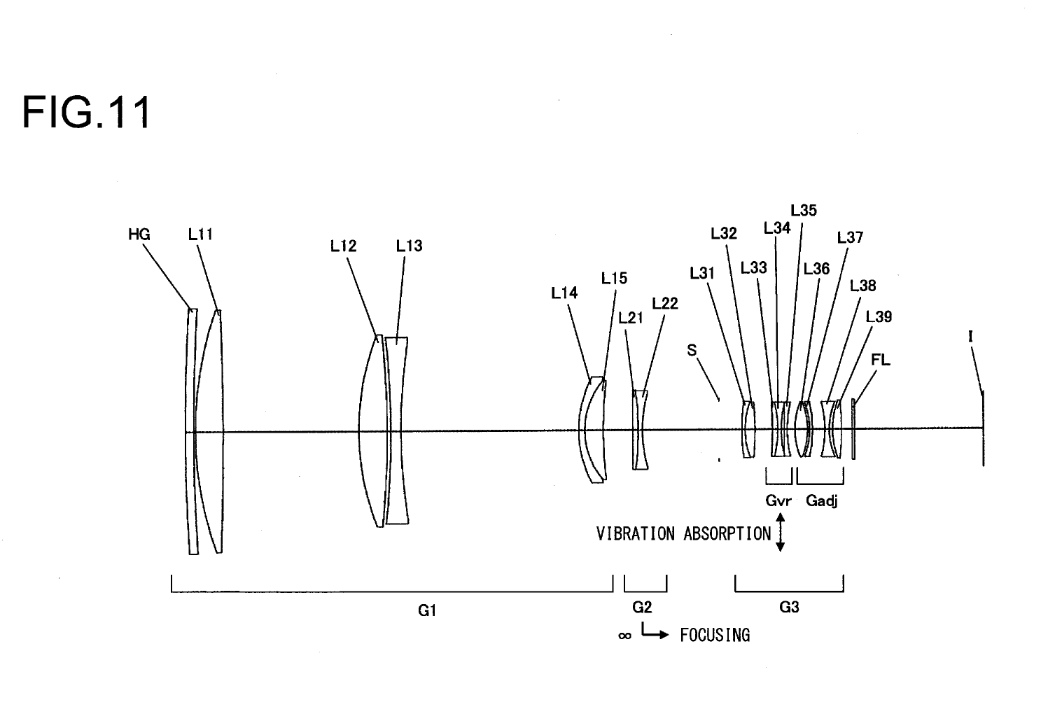

FIG. 11 is a figure showing a sectional view of the structure of the optical system in a fourth example.

As shown in FIG. 11, the optical system in the example is constituted with a first lens group G1 having a positive refractive power, a second lens group G2 having a negative refractive power, an aperture stop S, and a third lens group having a positive refractive power, disposed in this order along the optical axis, starting on the object side.

The first lens group G1 is constituted with a protective filter glass HG having a considerably weak refractive power, with its convex surface facing the object side, a bi-convex lens L11, a bi-convex lens L12, a bi-concave lens L13, and a cemented lens that is constituted with a negative meniscus lens L14 with its convex surface facing the object side and a positive meniscus lens L15 with its convex surface facing the object side, disposed in this order along the optical axis, starting on the object side.

The second lens group G2 is constituted with a cemented lens that is constituted with a plano-convex lens L21 with its plane facing the object side and a bi-concave lens L22, disposed in this order along the optical axis, starting on the object side.

The third lens group G3 is constituted with a cemented lens that is constituted with a negative meniscus lens L31 with its convex surface facing the object side and a bi-convex lens L32, a cemented lens that is constituted with a positive meniscus lens L33 with its concave surface facing the object side and a bi-concave lens L34, a plano-concave negative lens L35 with its plane facing the object side, a bi-convex lens L36, a negative meniscus lens L37 with its concave surface facing the object side, a bi-concave lens L38, and a bi-convex lens L39, disposed along the optical axis in this order, starting on the object side.

At the image surface I side of the third lens group G3 is disposed a filter FL, such as a low pass filter.

On the image surface I is disposed an image sensor (not shown) that is constituted with a CCD, a CMOS, or the like.

The optical system in the example having adopted this structure allows focusing from an infinity-distance object to a short-distance object to be achieved by moving the second lens group G2 serving as a focusing lens group toward the image surface I side. Also, the image surface correction for image blurring, i.e., vibration absorption, is achieved by moving a vibration-proofing lens group Gvr, which includes a cemented lens that is constituted with the positive meniscus lens L33 and the bi-concave lens L34, and the plano-concave negative lens L35, in a direction having a component perpendicular to the optical axis to shift an image on the image surface I.

In the optical system in the example, the bi-convex lens L36, the negative meniscus lens L37 with its concave surface facing the object side, the bi-concave lens L38, and the bi-convex lens L39 constitute an adjustment lens group Gadj for assuring good correction of degradation of image forming performance due to manufacturing errors after the optical system is assembled.

Similarly to the first example, the adjustment lens group Gadj is constituted with a bi-concave negative lens Ln, a lens group G3adjA having a positive refractive power adjacently disposed at the image surface I side of the negative lens Ln, and a lens group G3adjB having a positive refractive power adjacently disposed at the object side of the negative lens Ln (see FIG. 2). In this example, the bi-concave lens L38 corresponds to the negative lens Ln, the bi-convex lens L39 corresponds to the lens group G3adjA, and the bi-convex lens L36 and the negative meniscus lens L37 with its concave surface facing the object side correspond to the lens group G3adjB. The air gap adjustment mechanism for adjusting the air gap between the negative lens Ln and the lens group G3adjA and the air gap adjustment mechanism for adjusting the air gap between the negative lens Ln and the lens group G3adjB are similar to those adopted in the first example.

Table 4 below lists data values pertaining to the optical system achieved in the example.

TABLE 4
Fourth Example
[Overall Specifications]

| | |
|---|---|
| f | 587.80 |
| FNO | 4.08 |
| 2ω | 4.19 |
| Y | 21.60 |
| TL | 469.10 |
| Air converted TL | 468.59 |
| BF | 82.77 |
| Air converted BF | 82.26 |

[Surface Data]

| Surface Number | r | d | nd | νd |
|---|---|---|---|---|
| Object Surface | ∞ | | | |
| 1) | 1200.5127 | 5.00 | 1.51680 | 63.88 |
| 2) | 1199.6476 | 1.00 | | |
| 3) | 225.0000 | 16.40 | 1.43385 | 95.25 |
| 4) | −1939.6468 | 80.00 | | |
| 5) | 161.4252 | 16.60 | 1.43385 | 95.25 |
| 6) | −625.3189 | 2.15 | | |
| 7) | −566.2858 | 6.00 | 1.61266 | 44.46 |
| 8) | 350.3515 | 104.80 | | |
| 9) | 70.3762 | 3.50 | 1.77250 | 49.62 |
| 10) | 47.5154 | 10.80 | 1.49782 | 82.57 |
| 11) | 243.3331 | (variable) | | |
| 12) | ∞ | 3.00 | 1.92286 | 20.88 |
| 13) | −206.7820 | 2.50 | 1.83481 | 42.73 |
| 14) | 82.7523 | (variable) | | |
| 15) | ∞ | 13.20 (aperture) | | |
| 16) | 125.8462 | 1.80 | 1.90265 | 35.73 |
| 17) | 46.6040 | 6.00 | 1.59319 | 67.90 |
| 18) | −146.6583 | 10.00 | | |
| 19) | −252.0989 | 3.20 | 1.78472 | 25.72 |
| 20) | −68.0010 | 2.00 | 1.49782 | 82.57 |
| 21) | 67.9727 | 1.70 | | |
| 22) | ∞ | 1.80 | 1.81600 | 46.59 |
| 23) | 75.4444 | 4.50 | | |
| 24) | 46.9590 | 7.40 | 1.61266 | 44.46 |
| 25) | −46.9590 | 1.15 | | |
| 26) | −46.2240 | 1.70 | 1.92286 | 20.88 |
| 27) | −75.1558 | 7.40 | | |
| 28) | −59.2874 | 2.45 | 1.59319 | 67.90 |
| 29) | 42.6190 | 1.95 | | |
| 30) | 51.7215 | 5.40 | 1.67003 | 47.14 |
| 31) | −154.5582 | 6.15 | | |
| 32) | ∞ | 1.50 | 1.51680 | 63.88 |
| 33) | ∞ | 75.12 | | |
| Image Surface | ∞ | | | |

[Variable Distance Data]

| | Infinite | Close-up Shooting Distance |
|---|---|---|
| forβ | 587.801 | −0.145 |
| d0 | ∞ | 3930.900 |
| d11 | 17.545 | 33.104 |
| d14 | 45.385 | 29.826 |

[Lens Group Data]

| Group | Starting Surface | f |
|---|---|---|
| 1 | 1 | 230.74 |
| 2 | 12 | −103.56 |
| 3 | 16 | 692.82 |

[Values Corresponding to Conditional Expressions]

```
  (1) f/fRA = 10.1
  (2) f/dR = 6.7
  (3) f/−fFA = 0.45
  (4) |R1A − R2A|/f = 0.015
  (5) (R1A + R2A)/f = 0.16
  (6) IIIA/IA · (y/f)² = 0.034
  (7) IIIA · (y/f)² = 0.023
  (8) dM/f = 0.003
  (9) f/fFB = 1.6
(10) dSA/f = 0.013
(11) f/−fRB = 3.3
(12) |R1B − R2B|/f = 0.027
(13) (R1B + R2B)/f = 0.23
(14) IIIB/IB · (y/f)² = 0.002
(15) −IB = 1.565
(16) TL3/f1 = 0.29
(17) TL/f = 0.80
(18) f/f12 = 0.84
```

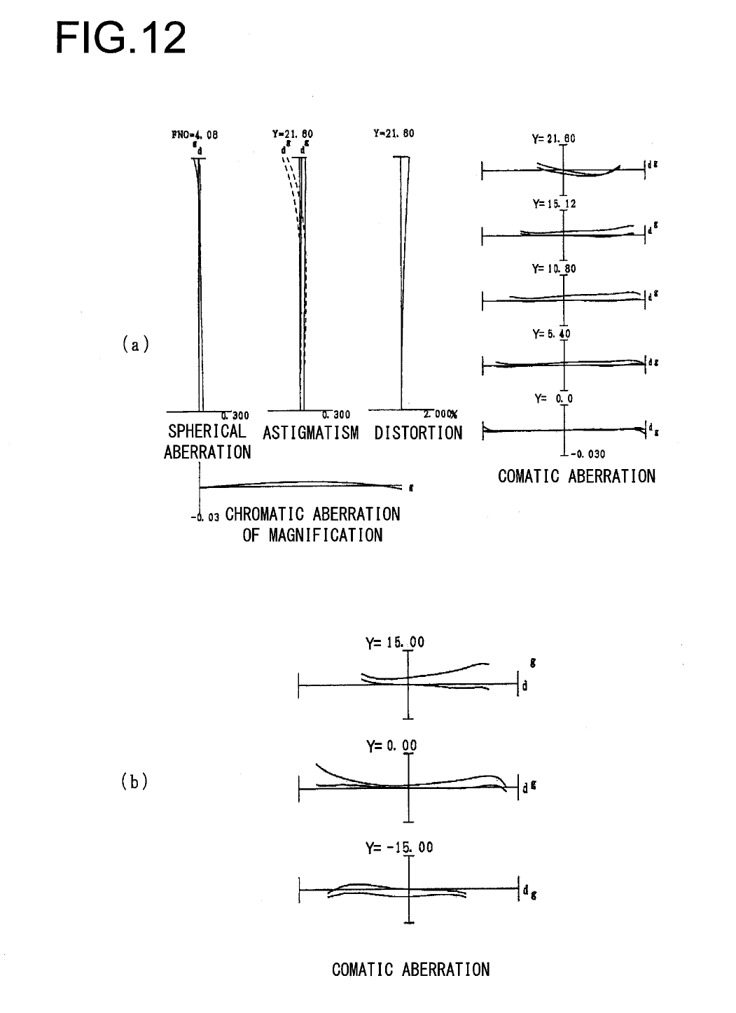

FIG. 12(a) is a figure showing various types of aberrations occurring at the optical system in the fourth example in an infinity-distance object in-focus state and FIG. 12(b) is a figure showing a lateral aberration in a vibration-proofing state.

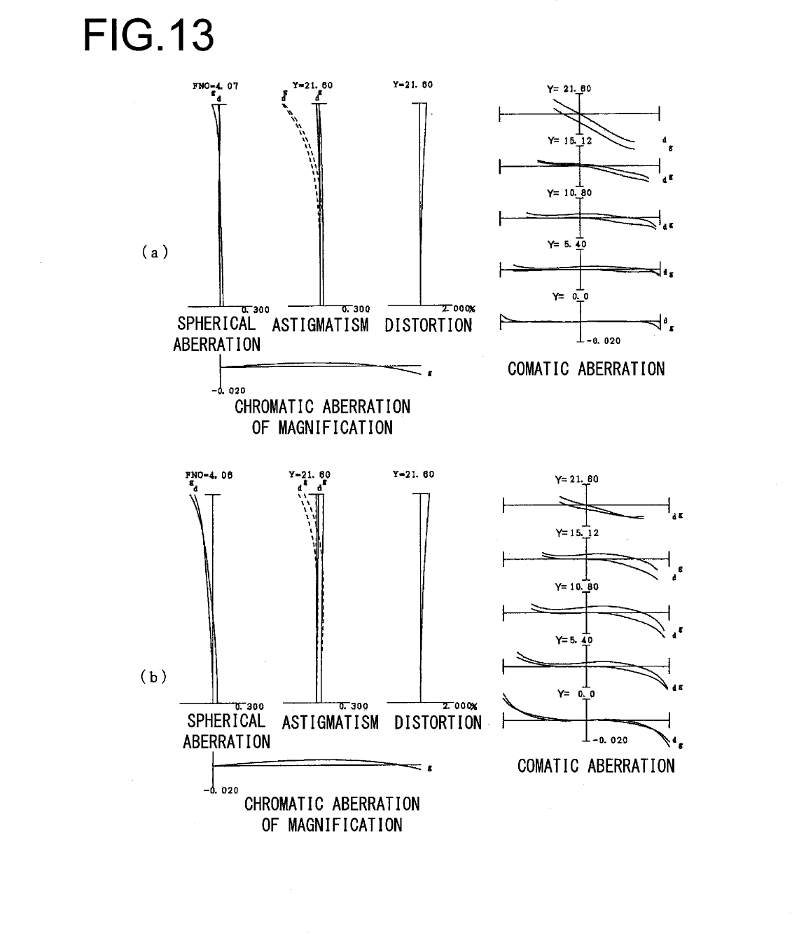

FIG. 13(a) is a figure showing various types of aberrations occurring at the optical system in the fourth example when the surface distance d29 is made by 0.2 mm larger than the design value and FIG. 13(b) is a figure showing various types of aberrations when the surface distance d27 is made by 0.2 mm larger than the designed value.

As will be apparent from FIGS. 12(a) and 12(b), it can be seen that the optical system pertaining to the fourth example will assure good correction of various types of aberrations and has excellent image forming performance.

Also, it is apparent from FIG. 13(a) that the astigmatism is shifted to be negative and the aberration caused by manufacturing errors can be corrected.

Also, it is apparent from FIG. 13(b) that the spherical aberration is shifted to be negative and the aberration caused by manufacturing errors can be corrected.

As explained above, each of the examples described above will assure easy correction of various types of aberrations, in particular, astigmatism and spherical aberration caused by manufacturing errors, in a short process of operation. In addition, since the adjustment mechanism adopted for correcting various types of aberrations has a simple structure, it is possible to achieve an optical system which is small-sized and which has a high level of optical performance at a low cost.

Note that the examples described above are merely examples of the embodiment and the embodiment is not limited thereto. The following contents may be adopted in the embodiment so far as the optical performance of the optical system in the embodiment is not damaged.

While examples of the optical system each constituted with three lens groups have been presented as specific numerical examples of the optical system in the embodiment, other configurations of lens groups, for example, those constituted with four lens groups may also be adopted in the invention. Furthermore, a configuration in which a lens or a lens group is added at a position closest to the object side or a configuration in which a lens or a lens group is added at a position closest to the image side may also be adopted in the invention. Note that “lens group” refers to a part or portion having at least one lens, which is separated by an air gap.

The optical system in the embodiment may be configured such that the focusing lens group is constituted with a single lens group or a plurality of lens groups or a partial lens group and is movable in a direction along the optical axis to achieve focusing from an infinity-distance object to a short-distance object. Such a focusing lens group can also be used for autofocusing operation and is optimal for motor drive for autofocus operation, such as motor drive by using an ultrasonic motor or the like. It is particularly preferable to use the second lens group G2 as the focusing lens group

The optical system in the embodiment may be configured such that a lens group or a partial lens group is movable in a direction having a component perpendicular to the optical axis, or is rotationally movable in a direction including the optical axis (i.e., swingable) to form a vibration-proofing lens group that corrects the image blurring due to camera shaking. In particular, it is preferable to use at least a part of the third lens group G3 as a vibration-proofing lens group.

A lens surface of lenses which constitute the optical system of the embodiment may be formed as a spherical lens surface, a planar lens surface or an aspherical lens surface. A spherical or planar lens surface is preferable in that the lens can be machined with ease and facilitates assembly and adjustment, which makes it possible to prevent degradation of optical performance due to errors occurring during the machining, assembly and adjustment processes. In addition, it is further preferable in that even in the event of an image surface misalignment, the extent of degradation in imaging performance is limited. An aspherical lens surface may be formed through grinding, or an aspherical surface may be a glass mold aspherical shape constituted of glass formed in an aspherical shape with a mold or a composite aspherical surface constituted of resin disposed at the surface of glass and formed in an aspherical shape. Furthermore, a lens surface may be formed as a diffractive surface, or a lens may be formed as a gradient index lens (GRIN lens) or a plastic lens.

It is preferable that the aperture stop S of the optical system in the embodiment be disposed near the third lens group G3. However, a configuration may be adopted in which no member for an aperture stop is provided but instead the frame of the lens is used to achieve the function of the aperture stop.

An anti-reflection film achieving a high level of transmittance over a wide wavelength range may be disposed at the individual lens surfaces constituting the optical system in the embodiment so as to reduce the extents of flare and ghosting and assure high-contrast optical performance.

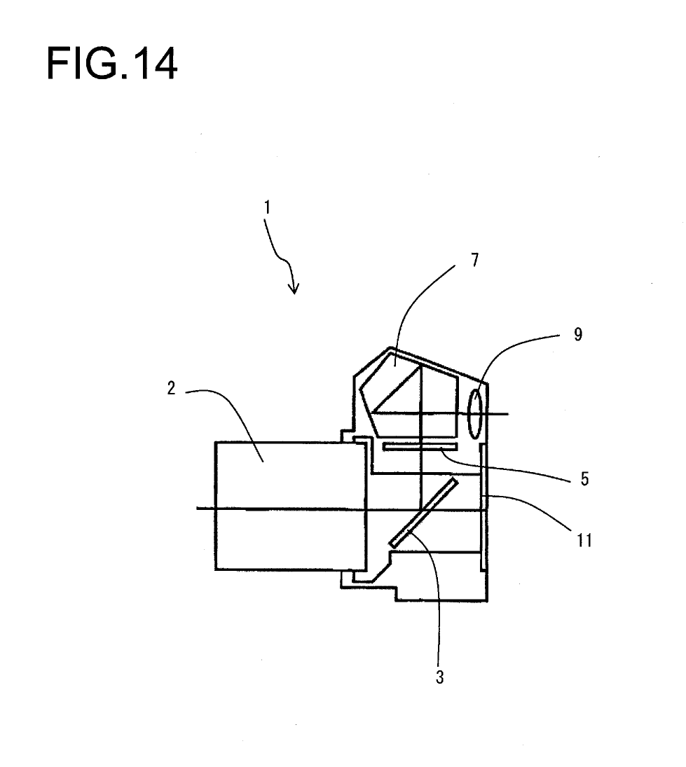

Next, a camera provided with the optical system in the embodiment is explained with reference to FIG. 14.

FIG. 14 is a figure showing the structure of a camera provided with the optical system in the embodiment.

As shown in FIG. 14, a camera 1 is a digital single lens reflex camera provided with the optical system according to the first example as a photographic lens 2.

In the camera 1 shown in FIG. 14, light from an object (photographic subject) (not shown) is condensed at the photographic lens 2 and an image is formed via a quick-return mirror 3 on a focusing screen 5. The light having formed an image at the focusing screen 5 is reflected a plurality of times within a pentaprism 7 and is then guided to an eyepiece lens 9. The photographer is thus able to view an object (photographic subject) image as an upright image via the eyepiece lens 9.

As the photographer presses a shutter release button (not shown), the quick-return mirror 3 retreats to a position outside the optical path, and the light from the object (photographic subject) (not shown), condensed at the photographic lens 2, forms a subject image on an image sensor 11. Thus, an image is captured at the image sensor 11 with the light from the object and the image thus captured is recorded as an object image into a memory (not shown). Through this process, the photographer is able to photograph the object with the camera 1.

Here, the optical system according to the first example mounted on the camera 1 as the photographic lens 2 assures easy correction of various types of aberrations caused by manufacturing errors in a short process of operation after the optical system is assembled and is an optical system that is small-sized and that has a high level of optical performance. Therefore, the camera 1 is a camera having a high level of optical performance. Note that cameras having mounted therein the optical systems according to the second to fourth examples, respectively, can achieve the same effects as the effect achieved by the camera 1. Furthermore, the camera 1 may be configured to detachably hold the photographic lens 2 or may be integrally formed together with the photographic lens 2. The camera 1 may be a camera that has no quick return mirror or the like.

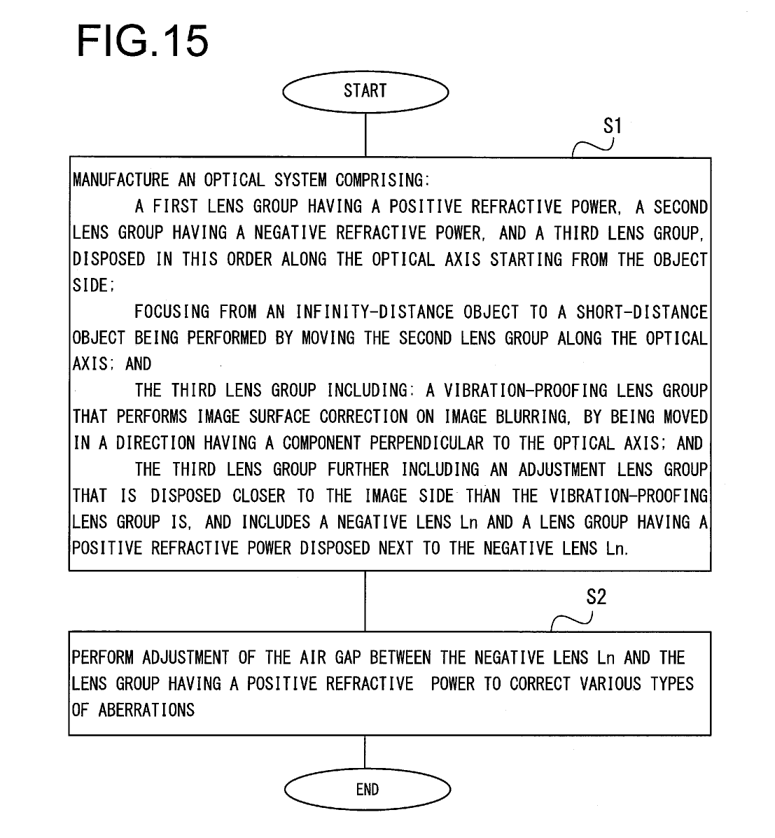

FIG. 15 is a flowchart that illustrates the procedure of a method for adjusting the optical system in the embodiment. In step S1, an optical system is manufactured, which includes a first lens group having a positive refractive power, a second lens group having a negative refractive power, and a third lens group, disposed in this order along the optical axis, starting on the object side, wherein the second lens group is moved along the optical axis to perform focusing from an infinity-distance object to a short-distance object, the third lens group includes a vibration-proofing lens group that performs image plane correction on image blurring by being moved in a direction having a component perpendicular to the optical axis, and wherein the third lens group further includes an adjustment lens group that is disposed closer to the image side than the vibration-proofing lens group is, that includes a negative lens Ln and a lens group having a positive refractive power disposed next to the negative lens Ln. After the optical system is manufactured, the procedure proceeds to step S2. In step S2, adjustment of an air gap between the negative lens Ln and the lens group having a positive diffractive power is performed to correct various types of aberration.

As explained above, the embodiment can provide an optical system that assures easy correction of various types of aberrations, in particular astigmatism and spherical aberration caused by manufacturing errors in a short process of operation and that is small-sized and has a high level of optical performance, and the embodiment enables an optical device provided with such an optical system, and a method for adjusting such an optical system to be achieved.

The disclosure of the following priority application is herein incorporated by reference:

Japanese Patent Application No. 2015-038234 (filed on Feb. 27, 2015)

### REFERENCE SIGNS LIST

G1 first lens group
G2 second lens group
G3 third lens group
Gvr vibration-proofing lens group
Gadj adjustment lens group
R1 first lens holding frame
R2 second lens holding frame
R3 third lens holding frame
S1 gap adjustment member
N1 screw
S aperture stop
I image surface
1 optical device
2 photographic lens
3 quick return mirror
5 focusing screen
7 pentaprism
9 eyepiece lens
11 image sensor

1. An optical system, comprising:
a first lens group having a positive refractive power, a second lens group having a negative refractive power, and a third lens group, disposed in this order along an optical axis starting from an object side, wherein:
the second lens group is movable along the optical axis to perform focusing from an infinity-distance object to a short-distance object; and
the third lens group comprises: a vibration-proofing lens group configured to be movable in a direction having a component perpendicular to the optical axis to perform image surface correction on image blurring; and an adjustment lens group that is disposed closer to an image side than the vibration-proofing lens group is, the adjustment lens group including a negative lens Ln and a lens group having a positive refractive power, disposed next to the negative lens Ln, and the adjustment lens group being capable of adjusting an air gap between the negative lens Ln and the lens group having a positive refractive power.

2. The optical system according to claim 1, wherein:
the lens group having a positive refractive power in the adjustment lens group is a lens group G3adjA having a positive refractive power, disposed at the image side of the negative lens Ln.

3. The optical system according to claim 1, wherein:
the lens group having a positive refractive power in the adjustment lens group is a lens group G3adjB having a positive refractive power, disposed at the object side of the negative lens Ln.

4. The optical system according to claim 1, wherein:
the lens group having a positive refractive power in the adjustment lens group includes the lens group G3adjA having a positive refractive power disposed at the image side of the negative lens Ln and the lens group G3adjB having a positive refractive power disposed at the object side of the negative lens Ln.

5. The optical system according to claim 2, wherein:
the lens group G3adjA is constituted with one positive lens.

6. The optical system according to claim 3, wherein:
the lens group G3adjB is constituted with at most two lenses.

7. The optical system according to claim 3, wherein:
the lens group G3adjB is constituted with one positive lens or with a combination of one positive lens and one negative lens.

8. The optical system according to claim 4, wherein:
the negative lens Ln is in a bi-concave form.

9. The optical system according to claim 2, wherein:
a conditional expression (1) below is satisfied:
3.0<f/fRA<15.0 (1)
where:
f: a focal length of the optical system in whole; and
fRA: a combined focal length of the lens group G3adjA through a lens located closest to the image side.

10. The optical system according to claim 2, wherein:
a conditional expression (2) below is satisfied:
2.0<f/dR<10.0 (2)
where:
f: a focal length of the optical system in whole; and
dR: a distance on the optical axis from a lens surface in the lens group G3adjA, which is located closest to the object side, to an image surface.

11. The optical system according to claim 2, wherein:
a conditional expression (3) below is satisfied:
0.10<f/−fFA<1.00 (3)
where:
f: a focal length of the optical system in whole; and
fFA: a combined focal length of a lens which is located closest to the obj6ect side through the negative lens Ln.

12. The optical system according to claim 2, wherein:
conditional expressions (4) and (5) below are satisfied:

|R1A−R2A|/f<0.050 (4)
0.010<(R1A+R2A)/f<0.600 (5)
where:
R1A: a radius of curvature at a surface of the negative lens Ln on the image side;
R2A: a radius of curvature at a surface of the lens group G3adjA on the object side; and
f: a focal length of the optical system in whole.

13. The optical system according to claim 2, wherein:
a conditional expression (6) below is satisfied:
0.005<IIIA/IA·(y/f)² (6)
where:
IIIA: a sum of coefficients of third-order astigmatism from the lens group G3adjA to a lens located closest to the image side in a state where the focal length of the optical system in whole is normalized to be 1;
IA: a sum of coefficients of third-order spherical aberration from the lens group G3adjA to the lens located closest to the image side in a state where the focal length of the optical system in whole is normalized to be 1;
y: a maximum image height of the optical system; and
f: a focal length of the optical system in whole.

14. The optical system according to claim 2, wherein:
a conditional expression (7) below is satisfied:
0.005<IIIA·(y/f)²<0.060 (7)
where:
IIIA: a sum of coefficients of third-order astigmatism from the lens group G3adjA to a lens located closest to the image side in a state where the focal length of the optical system in whole is normalized to be 1;
y: a maximum image height of the optical system; and
f: a focal length of the optical system in whole.

15. The optical system according to claim 2, wherein:
in the third lens group, the negative lens Ln and the lens group G3adjA with its convex surface facing the object side are disposed next to each other in this order, starting from the object side.

16. The optical system according to claim 2, wherein:
a conditional expression (8) below is satisfied:
0.001<dM/f<0.010 (8)
where:
dM: a distance of an air gap between the negative lens Ln and the lens group G3adjA along the optical axis; and
f: a focal length of the optical system in whole.

17. The optical system according to claim 2, wherein:
the negative lens Ln is held by a first holding member and the lens group G3adjA is held by a second holding member.

18. The optical system according to claim 17, wherein:
the air gap between the negative lens Ln and the lens group G3adjA is adjustable by varying a number of gap adjustment members disposed as sandwiched between the first holding member and the second holding member.

19. The optical system according to claim 3, wherein:
a conditional expression (9) below is satisfied:
1.00<f/fFB<2.70 (9)
where:
f: a focal length of the optical system in whole; and
fFB: a combined focal length of a lens located closest to the object side through the lens group G3adjB.

20. The optical system according to claim 3, wherein:
a conditional expression (10) below is satisfied:
0.0050<dSA/f<0.0500 (10)
where:
dSA: a distance of an air gap between the lens group G3adjB and the negative lens Ln along the optical axis; and
f: a focal length of the optical system in whole.

21. The optical system according to claim 3, wherein:
a conditional expression (11) below is satisfied:
1.3<f/−fRB<6.5 (11)
where:
f: a focal length of the optical system in whole; and
fRB: a combined focal length of the negative lens Ln through a lens located closest to the image side.

22. The optical system according to claim 3, wherein:
conditional expressions (12) and (13) below are satisfied:

|R1B−R2B|/f<0.150 (12)
0.150<(R1B+R2B)/f<0.500 (13)
where:
R1B: a radius of curvature at a surface of the lens group G3adjB on the image side;
R2B: a radius of curvature at a surface of the negative lens on the object side; and
f: a focal length of the optical system in whole.

23. The optical system according to claim 3, wherein:
a conditional expression (14) below is satisfied:
IIIB/IB·(y/f)²<0.010 (14)
where:
IIIB: a sum of coefficients of third-order astigmatism from the negative lens Ln to a lens located closest to the image side in a state where the focal length of the optical system in whole is normalized to be 1;
IB: a sum of coefficients of third-order spherical aberration from the negative lens Ln to a lens located closest to the image side in a state where the focal length of the optical system in whole is normalized to be 1;
y: a maximum image height of the optical system; and
f: a focal length of the optical system in whole.

24. The optical system according to claim 3, wherein:
a conditional expression (15) below is satisfied:
1.20<−IB<4.70 (15)
where:
IB: a sum of coefficients of third-order spherical aberration from the negative lens to a lens located closest to the image side in a state where the focal length of the optical system in whole is normalized to be 1.

25. The optical system according to claim 3, wherein:
in the third lens group, the lens group G3adjB with its convex surface facing the object side and the negative lens Ln are disposed next to each other in this order, starting from the object side.

26. The optical system according to claim 3, wherein:
the negative lens Ln is held by a first holding member and the lens group G3adjB is held by a third holding member.

27. The optical system according to claim 26, wherein:
the air gap between the negative lens Ln and the lens group G3adjB is adjustable by varying a number of gap adjustment members disposed as sandwiched between the first holding member and the third holding member.

28. The optical system according to claim 4, wherein:
the negative lens Ln is held by a first holding member, the lens group G3adjA is held by a second holding member, and the lens group G3adjB is held by a third holding member.

29. The optical system according to claim 28, wherein:
the air gap between the negative lens Ln and the lens group G3adjA is adjustable by varying a number of gap adjustment members disposed as sandwiched between the first holding member and the second holding member, and the air gap between the negative lens Ln and the lens group G3adjB is adjustable by varying a number of gap adjustment members disposed as sandwiched between the first holding member and the third holding member

30. The optical system according to claim 1, wherein:
a conditional expression (16) below is satisfied:
0.20<TL3/f1<0.50 (16)
where:
TL3: a distance on the optical axis from a lens surface of the third lens group located closest to the object side to a lens surface of the third lens group located closest to the image side; and
f1: a focal length of the first lens group.

31. The optical system according to claim 1, wherein:
a conditional expression (17) below is satisfied:
0.65<TL/f<1.15 (17)
where:
TL: a distance on the optical axis from a lens surface of the optical system in whole located closest to the object side to a lens surface of the optical system in whole located closest to the image side; and
f: a focal length of the optical system in whole.

32. The optical system according to claim 1, wherein:
a conditional expression (18) below is satisfied:
0.30<f/f12<1.00 (18)
where:
f: a focal length of the optical system in whole; and
f12: a combined focal length of the first lens group and the second lens group in an infinity-distance object in-focus state.

33. The optical system according to claim 1, wherein
the second lens group is movable along the optical axis toward the image side to perform focusing from an infinity-distance object to a short-distance object.

34. An optical device comprising the optical system according to claim 1.

35. A method for adjusting an optical system that includes
a first lens group having a positive refractive power, a second lens group having a negative refractive power, and a third lens group, disposed in this order along an optical axis starting from an object side, wherein
the second lens group is movable along the optical axis to perform focusing from an infinity-distance object to a short-distance object; and
the third lens group has a vibration-proofing lens group that is movable in a direction having a component perpendicular to the optical axis to perform image surface correction on image blurring, wherein:
the third lens group further includes an adjustment lens group that is constituted with a negative lens Ln and a lens group having a positive refractive power next to the negative lens, and that is located closer to an image side than the vibration-proofing lens group is; and
an air gap between the negative lens Ln and the lens group having a positive refractive power is adjusted.

36. The method for adjusting an optical system according to claim 35, wherein:
the lens group having a positive refractive power of the adjustment lens group is a lens group G3adjA having a positive refractive power, disposed on the image side of the negative lens Ln.

37. The method for adjusting an optical system according to claim 35, wherein:
the lens group having a positive refractive power of the adjustment lens group is a lens group G3adjB having a positive refractive power, disposed on the object side of the negative lens Ln.
